(19) United States
(12) Patent Application Publication
(10) Pub. No.: US 2003/0157391 A1
(43) Pub. Date: Aug. 21, 2003

(54) Silane coated metallic fuel cell components and methods of manufacture

(75) Inventors: Ernest A. Coleman, Stamford, CT (US); Jeffrey P. Allen, Naugatuck, CT (US)

Correspondence Address: BANNER & WITCOFF, LTD., 28 STATE STREET, 28th FLOOR, BOSTON, MA, 02109-9601, US

(73) Assignee: GenCell Corporation, Southbury, CT

(21) Appl. No.: 10/358,736

(22) Filed: Feb. 5, 2003

Related U.S. Application Data
(60) Provisional application No. 60/354,554, filed on Feb. 5, 2002.

(51) Int. Cl. H01M 8/02; H01M 8/10; B05D 5/12; B32B 15/04

(52) U.S. Cl. 429/34; 429/30; 427/115; 428/457

(57) ABSTRACT

Metallic fuel cell components that are at least partially coated with a coating comprising silane are provided. Methods of protecting a metallic fuel cell component from corrosion is provided, in which the methods comprise at least partially coating a fuel cell bipolar separator plate with a coating comprising a silane. Also included are fuel cells and fuel cell stacks comprising such metallic fuel cell components and methods for manufacturing such.

### CROSS-REFERENCE TO RELATED APPLICATIONS

This application claims priority to Provisional Patent Application No. 60/354,554, filed Feb. 5, 2002, hereby incorporated by reference in its entirety for all purposes.

### FIELD OF INVENTION

This invention relates to anti-corrosion coatings for metallic fuel cell components that are used, for example, in proton exchange membrane fuel cells and direct methanol fuel cells.

### BACKGROUND OF THE INVENTION

A fuel cell stack consists of multiple planar cells stacked upon one another, to provide an electrical series relationship. Each cell is comprised of an anode electrode, a cathode electrode, and an electrolyte member. A device known in the art by such names as a bipolar separator plate, an interconnect, a separator, or a flow field plate, separates the adjacent cells of a stack of cells in a fuel cell stack. The bipolar separator plate may serve several additional purposes, such as providing mechanical support to withstand the compressive forces applied to hold the fuel cell stack together, providing fluid communication of reactants and coolants to respective flow chambers, and providing a path for current flow generated by the fuel cell. The plate also may provide a means to remove excess heat generated by the exothermic fuel cell reactions occurring in the fuel cells.

Bipolar separator plates have typically been produced in a discontinuous mode, utilizing highly complex tooling that produces a plate with a finite cell area or utilizing a mixture of discontinuously and continuously manufactured sheet-like components that are assembled to produce a single plate possessing a finite cell area. Examples of such discontinuous methods include U.S. Pat. No. 6,040,076 to Reeder, which discloses Molten Carbonate Fuel Cell (MCFC) bipolar separator plates die formed with a specific finite area; U.S. Pat. No. 5,527,363 to Wilkinson et. al., which discloses Proton Exchange Membrane Fuel Cell (PEMFC) embossed fluid flow field plates, also die formed with a discrete finite area; and U.S. Pat. No. 5,460,897 to Gibson et. al., which discloses Solid Oxide Fuel Cell (SOFC) interconnects produced having a finite area. Each of these patents is incorporated herein by reference in their entirety for all purposes.

While carbon graphite, polymers, and ceramics are common examples of the materials of choice for the bipolar separator plate of the various fuel cell types, sheet metal can also be found as an example of the material of choice for each of the fuel cell types. For example, the MCFC bipolar separator plate of Reeder can be metallic; U.S. Pat. No. 5,776,624 to Neutzler discloses a metallic PEMFC bipolar separator plate; Gibson discloses a metallic SOFC bipolar separator plate; and U.S. Pat. No. 6,080,502 to Nolscher et. al. discloses a metallic bipolar separator plate for fuel cells, including a Phosphoric Acid Fuel Cell (PAFC) and an Alkaline Fuel Cell (AFC). The use of sheet metal, or metal foil, for construction of the bipolar separator plate permits the application of high-speed manufacturing methods such as continuous progressive tooling. The use of such metals for bipolar separator plate construction further provides for high strength and compact design of the assembled fuel cell.

Polymer electrolyte membrane or proton exchange membrane (PEM) fuel cells are particularly advantageous because they are capable of providing potentially high energy output while possessing both low weight and low volume. Each such fuel cell comprises a membrane-electrode assembly comprising a thin, proton-conductive, polymer membrane-electrolyte having an anode electrode film formed on one face thereof and a cathode electrode film formed on the opposite face thereof. In general, such membrane-electrolytes are made from ion exchange resins, and typically comprise a perfluorinated sulfonic acid polymer, such as, for example, NAFION™ available from E. I. DuPont DeNemours & Co. The anode and cathode films typically comprise finely divided carbon particles, very finely divided catalytic particles supported on the internal and external surfaces of the carbon particles, and proton-conductive material intermingled with the catalytic and carbon particles, or catalytic particles dispersed throughout a polytetrafluoroethylene (PTFE) binder.

NAFION membranes are fully fluorinated TEFLON™-based polymers with chemically bonded sulfonic acid groups that promote the transport of hydrogen ions during operation of the fuel cell. These membranes are advantageous in that they exhibit exceptionally high chemical and thermal stability. However, it is presently believed that some metallic alloys that are commercially and economically viable candidates for PEM applications may be subject to corrosion if the alloy comes into contact with NAFION membrane material. This corrosion of the metal alloys results in the subsequent liberation of corrosion product in the form of metallic ions, such as Fe, that may then migrate to the proton exchange membrane and contaminate the sulfonic acid groups, thus diminishing the performance of the fuel cell.

U.S. Pat. No. 5,858,567 to Spear, Jr. et al. discloses a separator plate comprised of a plurality of thin plates into which numerous intricate microgroove fluid distribution channels have been formed. These thin plates are then bonded together and coated or treated for corrosion resistance. The corrosion resistance of Spear, Jr. et al. is brought about by reacting nitrogen with the titanium metal of the plates at very high temperatures, for example between 1200° F. and 1625° F., to form a titanium nitride layer on exposed surfaces of the plate.

European Patent No. 0007078 to Pellegri et al. discloses a bipolar interconnector, for use in a solid polymer electrolyte cell, that is comprised of an electrically conductive powdered material, for example graphite powder and/or metal particles, mixed with a chemically resistant resin, into which an array of electrically conductive metal ribs are partially embedded. The exposed part of the metal ribs serves to make electrical contact with the anode. The entire surface of the separator, with the exception of the area of contact with the anode, is coated in a layer of a chemically resistant, electrically non-conductive resin. The resin can be a thermosetting resin such as polyester, phenolics, furanic and epoxide resins, or can be a heat resistant thermoplastic such as halocarbon resins. This resin coating layer serves to electrically insulate the surface of the separator.

The separator plate of a fuel cell typically serves multiple purposes. The separator plate acts as a housing for the reactant gases to avoid leakage to the atmosphere and cross-contamination of the reactants; acts as a flow field for the reactant gases to allow access to the reaction sites at the electrode/electrolyte interfaces; and acts as a current collector for the electronic flow path of the series connected flow cells. In many cases the separator plate is comprised of multiple components to achieve these purposes, typically including a separator plate and one or more current collectors. Typically, three to four separate components or sheets of material are needed, depending on the flow configurations of the fuel cell stack. It is frequently seen that one sheet of material is used to provide the separation of anode/cathode gases while two additional sheets are used to provide the flow field and current collection duties for the anode and the cathode sides of the separator. Examples of such current collectors include U.S. Pat. Nos. 4,983,472 and 5,503,945. Such current collectors have typically utilized sheet metal in one form or another, perforated in a repetitive pattern to simplify manufacture and to maximize access of reactant gases to the electrodes. This sheet metal is exposed to the same anode and cathode environments as the separator plate, and is thus subject to the same corrosion problems as the separator plate. U.S. Pat. No. 4,983,472 teaches current collectors made of a high strength alloy that is nickel plated for corrosion resistance. The nickel plating adds significant expense to the manufactured cost of the current collector.

Bipolar separator plates and current collectors produced with a discontinuous finite area do not enjoy the advantages of continuous production methods, which are commonly used to produce the electrodes and electrolyte members of the fuel cell. Continuous production methods provide cost and speed advantages and minimize part handling. Continuous production, using what is known as progressive tooling, allows the use of small tools that are able to produce large plates and collectors from sheet material. The plate disclosed in Reeder is capable of being produced in a semi-continuous fashion, but requires tooling possessing an area equivalent to that of the finished bipolar plate area, which in Reeder can be up to eight square feet. The plate described in Reeder also requires separately produced current collectors for both the anode and cathode. These current collectors may be produced in a continuous fashion, however, the resultant assembly of the three sheets of material is intensive. Also, the area of the plate created by the design is fixed and unalterable unless retooled. Other common production methods that utilize molds to produce plates from non-sheet material, such as injection molding with polymers, are wholly unable to stream the production process in a continuous mode. As a result, discontinuous production methods require complex tooling and are speed limited. Complex tooling further inhibits design evolution due to the costs associated with replacing or modifying the tools.

A need exists for metallic fuel cell components, such as bipolar separator plates and current collectors to be resistant to the corrosive environment that may be encountered internal to a fuel cell, such as a proton exchange membrane fuel cell. It is an objective, therefore, to provide coated metallic fuel cell components that are resistant to corrosive environments within fuel cells.

### SUMMARY

In accordance with one aspect, a metallic fuel cell component is provided for use in low temperature fuel cells utilizing proton exchange membranes. The metallic fuel cell component is at least partially coated with a coating comprising a silane. The silane coating is preferably stable when in contact with or in close proximity to the proton exchange membrane (PEM) and within the anode and cathode environments of a fuel cell. As used herein, the term “close proximity” refers to portions of the plate that are close enough to the PEM to be corroded by the PEM. In certain preferred embodiments, the silane is of the formula (I):

(RO)_{P}SiR′_{N}R″_{M} (I)

where P+N+M=4 and P=1, 2 or 3;

R=CH₃—; CH₃(CH₂)ₙ—, where n=1-18; CH₃CO—; ethoxyethyl; or ethoxybutyl;

R′=CH₃—, CH₃(CH₂)₁₇—, H₂N(CH₂)₃—, or H₂N(CH₂)₂[NH(CH₂)₂]_{Q}HN(CH₂)₃—, where

Q=0

or 1; and

R″=H where R′=CH₃—; otherwise, M=0.

In other preferred embodiments, the silane is of the formula (II):

(RO)_{P}SiR′_{N}R″_{M} (II)

where P+N+M=4 and P=1, 2 or 3;

R=linear or branched alkyl groups of 1-19 carbon atoms, cycloalkyl groups of 3-19 carbon atoms, or alkyl aromatic groups;

R′=CH₃—, CH₃(CH₂)₁₇—, H₂N(CH₂)₃—, or H₂N(CH₂)₂[NH(CH₂)₂]_{Q}HN(CH₂)₃—, where

Q=0

or 1; and

R″=H where R′=CH₃—; otherwise, M=0.

Without wishing to be bound by theory, it is presently believed that the alkyl portion of the RO— group of the silane is removed during the coating process, typically by an acid, usually in the presence of a substrate, such as a metallic fuel cell component, that has —OH groups. The silane then bonds to the substrate —OH groups via the remaining —O³¹ substituent. As such, the R group can preferably be any non-corrosive group, as the substrate will be exposed to the R group upon its removal. The particular alkyl group is further believed to control the rate of the coating reaction. In certain preferred embodiments, another purpose of the alkyl portion of the RO— group is to prevent the silane from reacting with other silanes of the coating and forming oligomers and/or polymers.

In other preferred embodiments, the silane is of the formula (III):

ClₓSiR_{y} (III)

where y=1, 2 Or 3 and x=4−y; and

R=CH₃—; CH₃(CH₂)ₙ—, where n=1-18; CH₃CO—; ethoxyethyl; or ethoxybutyl.

In certain preferred embodiments, the silane contains at least one acylamino or cyano silane linkage and an R group, wherein R is an alkylene or arylene group or radical. Suitable acylamino silanes include, but are not limited to, gamma-ureidopropyltriethoxysilane, gamma-acetylaminopropyltriethoxysilane, delta-benzoylaminobutylmethyldiethoxysilane, and the like. Further suitable acylamino silanes and methods for preparation of such silanes include silanes and methods disclosed in U.S. Pat. Nos. 2,928,858, 2,929,829, 3,671,562, 3,754,971, 4,046,794, and 4,209,455, each of which is incorporated by reference in its entirety for all purposes. Preferably, the silanes comprise amino silanes such as, for example, ureido silanes, and in particular gamma-ureidopropyltriethoxysilane. Suitable cyanosilanes include, but are not limited to, cyanoeethyltrialkoxysilane, cyanopropytri-alkoxysilane, cyanoisobutyltrialoxysilane, 1-cyanobutyltrialkoxysilane, 1-cyanoisobutyltrialkoxysilane, cyanophenyltrialkoxysilane, and the like. It is also envisioned that partial hydrolysis products of such cyanosilanes and other cyanoalkylene or arylene silanes would be suitable for use in this invention. A more complete description of cyanosilanes can be found in Chemistry and Technology of Silicones by Walter Noll, Academic Press, 1968, pp. 180-189, incorporated herein in its entirety for all purposes. Other suitable aclyamino and cyano silanes will be readily apparent to those of skill in the art, given the benefit of the present disclosure.

In certain preferred embodiments, the silane is a mercaptosilane. Without wishing to be bound by theory, it is presently believed that mercaptosilanes are particularly adept at complexing with cations and thereby removing the cations from the solutions present in the fuel cell. Exemplary mercaptosilanes that are suitable for preferred embodiments of the silane coatings include silanes of the formula (IV):

(RO)_{c}SiR′_{d}R″ₑR′″_{f} (IV)

where c+d+e+f=4;

c=1, 2 or 3;

R=CH₃(CH₂)_{g}, where g=0-17 and R may be linear or branched; CH₃(CH₂)ₕ—O—CH₂(CH₂)ᵢ,

where h=0-4 and i=1, 2 or 3;

R′=—CH₂CH₂CH₂SH

R″=R′, H, or CH₃(CH₂)_{g}, where g=0-17 and R may be linear or branched; and

R′″=R″.

Also exemplary are silanes of the formula (V):

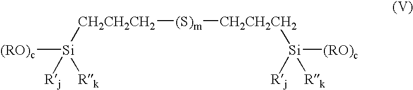

where c=1 or 2;

c+j+k=3; and

m=1 to 4.

Suitable mercaptosilanes include, for example, 3-glycidoxypropyltrimethoxysilane, 3-mercaptopropyltrimethoxysilane, 2-mercaptopropyltrimethoxysilane, 2-(3,4-epoxycyclohexyl)-ethyltrimethoxysilane, and partial hydrolyzates thereof. Other suitable mercaptosilanes will be readily apparent to those of skill in the art, given the benefit of this disclosure.

In other preferred embodiments, a tetrafunctional silane can be used. Such a silane can form a more complex coating, with cross-linking and greater depth of structure, i.e. thicker coatings, being possible. These silanes can be employed alone, or preferably can be added in small amounts, for example, from about 0.5% by weight of the finished, dried coating to about 20%, preferably from between about 2% to about 5%, to other silane coatings in accordance with those disclosed herein. Alternatively, such may also be employed in conjunction with additional coatings as described below. Suitable tetrafunctional silanes include tetraalkoxysilanes such as, for example, tetramethoxysilane, tetraethoxysilane, tetra-n-butoxysilane and the like.

Certain preferred embodiments employ at least one vinyl-polymerizable unsaturated, hydrolyzable silane containing at least one silicon-bonded hydrolyzable group, e.g., alkoxy, halogen, acryloxy, and the like, and at least one silicon-bonded vinyl-polymerizable unsaturated group. Exemplary of such include, for example, gamma-methacryloxypropyltrimethoxysilane, gamma-acryloxypropyltriethoxysilane, vinyltri(2-methoxyethoxy) silane, vinyltrimethoxysilane, vinyltriethoxysilane, vinyltrichlorosilane, vinyltriacetoxysilane, ethynytrimethoxysilane, ethynytriethoxysilane 2-propynyltrimethoxysilanesilane, 2-propynyltriethoxysilanesilane and 2-propynyltrichlorosilane and the like. Preferably, any valences of the silicon not satisfied by a hydrolyzable group or a vinyl-polymerizable unsaturated group contains a monovalent hydrocarbon group, e.g., methyl, ethyl, propyl, isopropyl, butyl, pentyl, isobutyl, isopentyl, octyl, decyl, cyclohexyl, cyclopentyl, benzyl, phenyl, phenylethyl, naphthyl, and the like. Isomers of such groups are also included. Suitable silanes of this type include those represented by the formula (VI):

RₐSiX_{b}Y_{c} (VI)

wherein R is a monovalent hydrocarbon group; X is a silicon-bonded hydrolyzable group; Y is a silicon-bonded monovalent organic group containing at least one vinylpolymerizable unsaturated bond; a is 0, 1 or 2, preferably 0; b is 1, 2 or 3, preferably 3; c is 1, 2 or 3, preferably 1; and a+b+c is equal to 4. Optionally, relatively low molecular weight vinyl-polymerizable unsaturated polysiloxane oligomers can be used in place of or in addition to the vinyl-polymerizable unsaturated, hydrolyzable silanes. Such relatively low molecular weight vinyl-polymerizable unsaturated polysiloxane oligomers and can typically be represented by the formula (VII):

R_{g}(R_{d}Y_{2-d}SiO)ₑ(R₂SiO)_{f}(SiR₃)_{g} (VII)

wherein R is a monovalent hydrocarbon group; Y is a silicon-bonded monovalent organic group containing at least one vinylpolymerizable unsaturated bond; d is 0 or 1; e is 1, 2, 3 or 4; f is 0, 1, 2 or 3; g is 0 or 1; e+f+g is equal to an integer of 1 to 5; and d can be the same or different in each molecule. Suitable oligomers include the cyclic trimers, cyclic tetamers and the linear dimers, trimers, tetramers and pentamers. The vinyl-polymerizable unsaturated silicon compounds, thus, preferably contain one to five silicon atoms, interconnected by —SiOSi— linkages when the compounds contain multiple silicon atoms per molecule, contain at least one silicon-bonded vinyl-polymerizable unsaturated group and are hydrolyzable, in the case of silanes, by virtue of at least one silicon-bonded hydrolyzable group. Any valences of silicon not satisfied by a divalent oxygen atom in a —SiOSi— linkage, by a silicon-bonded hydrolyzable group or by a silicon-bonded vinyl-polymerizable unsaturated group is satisfied by a monovalent hydrocarbon group free of vinyl-polymerizable unsaturation. The vinyl-polymerizable unsaturated, hydrolyzable silanes are preferred in most cases.

In certain preferred embodiments, silanes are of the formula (VIII):

(RO)ₘSiR′ₙR″ₒR′″ₚ (VIII)

where m+n+o+p=4 and m=1, 2 or 3;

R=CH₃—; CH₃(CH₂)_{q}—, where q=1-18 and the alkyl structure can be linear or branched;

CH₃CO—; or CH₃(CH₂)ᵣ—O—CH₂CH₂—, where r=0, 1, or 4;

R′=CH₃—; CH₃(CH₂)_{q}—, where q=1-18 and the alkyl structure can be linear or branched; or —CH₂CH₂CH₂—Z,

where Z=NH₂, CN, Cl, SH, H,

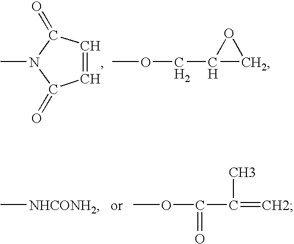

R″=R′ or R″; and

R′″=R″.

Certain other preferred embodiments include silanes that can be used to coat metallic surfaces in the vapor phase without using solvent. Included among these are silanes of the formula (IX):

ClₘSiR′ₙR″ₒR′″ₚ (IX)

where m+n+o+p=4 and m=1, 2 or 3;

R′=CH₃—; CH₃(CH₂)_{q}—, where q=1-18 and the alkyl structure can be linear or branched; or —CH₂CH₂CH₂—Z,

where Z=NH₂, CN, Cl, SH, H, or

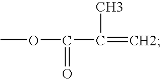

R″=H or R′; and

R′″=R″.

Also included are silanes of the formula (X):

(CH₃)₃Si—NH—Si(CH₃)₃. (X)

Further included are silanes of the formula (XI):

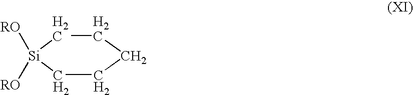

where R=CH₃—; CH₃(CH₂)_{q}—, where q=1-18 and the allyl structure can be linear or branched; CH₃CO—; or CH₃(CH₂)ᵣ—O—CH₂CH₂—, where r=0, 1, or 4.

Other suitable silanes for coating metallic surfaces of fuel cell components include 2-(3,4-epoxycyclohexyl)-ethyltrimethoxysilane and the silanes described, for example, in U.S. Pat. No. 4,481,322, incorporated herein by reference in its entirety for all purposes. Other suitable silanes will be readily apparent to those of skill in the art, given the benefit of the present disclosure.

Metallic fuel cell components, as used herein, includes any component of a fuel cell comprising a metal that is exposed to a corroding environment, such as, for example, the anode and cathode environments, when assembled into a fuel cell. Such components include, for example, bipolar separator plates and current collectors, and may include other components such as support components or other components of the fuel cell. The term also encompasses fuel cell components comprising materials capable of releasing contaminants, such as anions or cations, into the fuel cell where they may contaminate the PEM.

In certain preferred embodiments, the metallic fuel cell components may further be at least partially coated with one or more additional coatings. Suitable additional coatings include, for example, coatings comprising a silane or coatings comprising a polymer, including but not limited to the polymeric coatings disclosed in U.S. application Ser. No. 10/310,351, entitled “Polymer Coated Metallic Bipolar Separator Plate and Method of Assembly,” filed on Dec. 5, 2002, incorporated herein by reference in its entirety for all purposes. Such suitable polymers may themselves be conductive or nonconductive and are preferably also stable when in contact with or in close proximity to the proton exchange membrane and are stable in the cathode and anode environments of the fuel cell. Exemplary additional coatings include polymeric coatings such as polysulphones, polypropylenes, polyethylenes, TEFLON™ and the like. Other suitable additional coatings will be readily apparent to one of ordinary skill in the art, given the benefit of this disclosure.

The additional coating in certain preferred embodiments may cover the same areas covered by the silane coatings, may cover more or less area than is covered by the silane coatings, or may cover entirely different areas than is coated by the silane coatings. In certain preferred embodiments, the silane coating is sandwiched between the additional coating and the metallic fuel cell component, and the silane coating in such an arrangement may optionally serve to adhere the additional coating to the metallic fuel cell component or may optionally serve to prime or treat the surface of the metallic fuel cell component for acceptance of the additional coating. It is understood that coatings comprising a silane, as used herein, encompasses coatings that comprise more than one type of silane as well as coatings that comprise a single type of silane. For embodiments in which an additional coating comprising a polymer is employed, the polymer may comprise conductive polymer, non-conductive polymer, and mixtures of the two. Other suitable multiple coating arrangements will be readily apparent to those of ordinary skill in the art, given the benefit of the present disclosure.

In certain preferred embodiments the peaks and valleys comprising the flow channels of the central active area of a bipolar separator plate are coated with a silane-comprising coating prior to the final forming and assembly of the bipolar plate. In other preferred embodiments, the current collector is coated with a silane-comprising coating prior to the final forming and assembly of the current collector. Optionally, both the bipolar separator plate and the current collector are so coated. However, an electrical contact is required at the interface of the peaks of the flow channels of the plate and the current collector. Therefore, the interface between the peaks of the flow channels of the central active area and the current collector must be conductive. In certain preferred embodiments, the silane coating is conductive, further enhancing the anti-corrosion effects of the coating. In other preferred embodiments, the silane coating is non-conductive, and the current collector is in direct contact with the separator plate. As used herein, the term “non-conductive” refers to conductivity that is insufficient to meet the requirements of the fuel cell. As such, materials that are non-conductive include materials that are relatively non-conductive, that is, materials that are conductive to a limited extent but are insufficiently conductive to be interposed between the current collector and the separator plate and permit the desired fuel cell output. In yet other preferred embodiments, the silane coating is non-conductive while permitting sufficient current to pass through the coating to achieve the desired cell properties. Without wishing to be bound by theory, it is presently believed that such silane coatings are of sufficient thinness, for example, as thin as a single molecular layer thick, to permit sufficient current to pass despite the fact that the coating itself is relatively non-conductive. In other words, the coating layer is so thin that it does not offer significant impedance to the flow of current despite being interposed between the current collector and the separator plate.

In accordance with another aspect, metallic fuel cell components are provided for use in low temperature fuel cells utilizing proton exchange membranes, wherein the metallic fuel cell components are at least partially coated with a coating comprising a silazane, optionally a polysilazane. In certain preferred embodiments, the silazane is hexamethyldisilazane (HMDS). The silazane coating can be used to partially or completely coat the separator plate in accordance with any of the embodiments disclosed herein. Other suitable silazanes will be readily apparent to those of skill in the art, given the benefit of the present disclosure.

In another aspect, a fuel cell utilizing proton exchange membranes is provided that comprises a metallic fuel cell component that is at least partially coated with a coating comprising a silane in accordance with the silanes disclosed herein. In preferred embodiments, the metallic fuel cell component is a current collector, preferably a flat wire current collector. In other preferred embodiments, the metallic fuel cell component is a bipolar separator plate. In yet other preferred embodiments, the metallic fuel cell components include both the current collector(s) and the bipolar separator plate.

In still another aspect, a fuel cell stack comprising at least one fuel cell utilizing PEM's, the fuel cell comprising a metallic fuel cell component that is at least partially coated with a coating comprising a silane in accordance with the silanes disclosed herein is provided.

In accordance with a method aspect, a method of protecting a metallic fuel cell component from corrosion is provided. The method comprises at least partially coating a metallic fuel cell component with a coating comprising a silane. Preferred embodiments include coating the metallic fuel cell component with coatings comprising any of the silanes disclosed above. In certain preferred embodiments, the method further comprises coating the metallic fuel cell component with an additional coating, such as, for example, a polymer layer of the type described above. The surfaces of metallic fuel cell component, which preferably comprises metal foil, for example, stainless steel, may in certain preferred embodiments be treated with acid, optionally hot acid, for example, sulfuric acid; rinsed with water, advantageously with deionized, demineralized distilled water; and further treated with water vapor. Typically, the treatment takes place prior to the coating of the metallic fuel cell component. Without wishing to be bound by theory, such treatment is presently thought to remove ions, such as cations that might otherwise contaminate the PEM, from the surfaces of the metallic fuel cell component. Optionally a treating solvent may be used to treat the surfaces of the metallic fuel cell component. Where it is desirable to have the surfaces of the separator plate free of water prior to coating, suitable solvents include those that can be made anhydrous by azeotropic distillation, for example, xylene. Where the presence of water on the surface of the metallic fuel cell component is acceptable, suitable solvents include water soluble solvents, for example, isopropanol. Such treatment is thought to clean and degrease the surfaces of the metallic fuel cell component, creating a cleaner surface for coating with the silane-comprising coating. The surface treatment steps may advantageously be both performed on the surfaces of the metallic fuel cell component. The treated surfaces may include the entirety of the surfaces of the metallic fuel cell component or may instead include only the portions of the surface that are to be coated. Other suitable treatment steps will be readily apparent to those skilled in the art, given the benefit of the present disclosure.

In certain preferred embodiments, the metallic fuel cell component is coated with the coating comprising a silane by immersing the plate in a silane coating liquid comprising a silane, dilute acid such as, for example, dilute acetic acid, demineralized, deionized water and optionally a silane coating liquid solvent, such as, for example, isopropanol, xylene or toluene. In other embodiments, the metallic fuel cell component is immersed in a silane coating liquid comprising a silane and a solvent, such as, for example, toluene or xylene. The selection and concentration of the components of the silane coating liquid typically depend on the nature of the silane being utilized. For example, typically the more polar silanes will be capable of being utilized with a silane coating liquid containing a greater water content than silanes of a lower polarity. If the polarity of the silane is sufficiently low, a silane coating liquid comprising only solvent may be optimal. Selection of particular silane coating liquids will be readily apparent to those of skill in the art, given the benefit of the present disclosure.

These and additional features and advantages of the invention disclosed here will be further understood from the following Detailed Description of Certain Preferred Embodiments.

### BRIEF DESCRIPTION OF THE SEVERAL VIEWS OF THE DRAWING

The aspects of the invention will become apparent upon reading the following detailed description in conjunction with the accompanying drawings, in which:

FIG. 1 illustrates a plan view of the anode side of a partially cut-away bipolar separator plate, diffusion layer, membrane/electrode assembly;

FIG. 2 illustrates a containment vessel for surface treatment of a metallic fuel cell component;

FIG. 3 illustrates a containment vessel for surface treatment of a metallic fuel cell component;

FIG. 4 illustrates a containment vessel for surface treatment of a metallic fuel cell component; and

FIG. 5 illustrates a schematic representation of a coil-coating line.

### DETAILED DESCRIPTION OF CERTAIN PREFERRED EMBODIMENTS

Unless otherwise indicated or unless otherwise clear from the context in which it is described, aspects or features disclosed by way of example within one or more aspects or preferred embodiments should be understood to be disclosed generally for use with other aspects and embodiments of the devices and methods disclosed herein.

In certain preferred embodiments, manufacture of the metallic fuel cell component that is to be coated is accomplished by producing repeated finite sub-sections of the metallic fuel cell component in continuous mode. The metallic fuel cell component may be cut to any desirable length in multiples of the repeated finite sub-section and processed through final assembly, or recoiled for further processing. The metallic fuel cell component in certain preferred embodiments comprises metal foil, for example, stainless steel, which is particularly suited to continuous mode production. Bipolar separator plates and current collectors, particularly flat wire current collectors as described in U.S. Pat. No. 6,383,677, are particularly well-suited to this type of construction.

In certain preferred embodiments, a current collector suited for coating with a silane-comprising coating comprises a plurality of parallel flat wires slit continuously from sheet metal and bonded to the face of an electrode on the side facing the respective flow field of the separator plate. Such a current collector is taught in U.S. Pat. No. 6,383,677, incorporated herein in its entirety for all purposes. The separator plate typically is formed with ribs. The flat wires, or strips, of the current collector are preferably narrow and are preferably spaced at sufficient frequency, or pitch, as to provide optimum access of the reactant gases of the fuel cell to the electrodes as well as to provide optimum mechanical support to the electrodes. The flat wires are preferably thin as to minimize material content and ease manufacturing constraints yet retain sufficient strength to react against the compressive sealing forces applied to the fuel cell stack at assembly. The flat wire current collectors are preferably continuously and simultaneously slit from sheet metal using a powered rotary slitting device and spread apart to the desired spacing through a combing device prior to an adhesive bonding to an electrode. The current collector/electrode assembly may then be cut to desired length for installation to the ribbed separator plate. The coating of this type of current collector is preferably performed following the slitting of the flat wires from the sheet metal, either before or after spreading the wires. Alternatively, the current collector may be slit from coil to be processed by the coating apparatus and then re-coiled for subsequent dispensing by a flat-wire current collector dispenser.

As discussed above, an electrical contact is required at the interface of the peaks of the flow channels of the separator plate and the current collector. Therefore, the interface between the peaks of the flow channels of the central active area and the current collector must be conductive. The coating may be applied only to those areas of the metallic foils that comprise the metal fuel cell component that are in intimate contact with, or close proximity to, the proton exchange membrane when the metal fuel cell component is incorporated into a fuel cell comprising a PEM, for example, the seal area at the perimeter of the bipolar separator plate where the membrane forms a seal between adjacent bipolar separator plates that separate adjacent cells in a stack of cells forming a fuel cell stack. In certain preferred embodiments, the coating serves to enhance the sealing ability of the separator plate, for example, by use of an eyeleted joint. The coating may preferably further be applied to the entire area of the metallic substrate comprising the bipolar separator plate to further enhance the encapsulation of the metal. In certain preferred embodiments, the silane coating is conductive such that the conductivity of the interface of the silane-coated peaks and the current collector is achieved without violation of the integrity of the encapsulating coating. In other preferred embodiments, the current collector is bonded, welded, or embedded into and through the silane coating in such a fashion that it does not violate the integrity of the coating, thus achieving conductivity. The conductivity may in still other preferred embodiments be achieved with an intermediary support element that is bonded, welded, or embedded into and through the silane coating in such a fashion that it does not violate the integrity of the coating. The intermediary support element may be a screen or a series of wires, which itself may optionally be coated with any of the silane-comprising coatings and optionally any of the additional coatings described herein. The intermediary support element may be comprised of a conductive material that is stable in the presence of the fuel cell environment, as for example carbon graphite fibers or noble metal wires, or fabrics and screens fabricated from said fibers and wires. Where the current collectors are in contact with the separator plate, or where the current collectors are in contact with a conductive intermediary support that is in contact with the separator plate such that electrical contact exists between the current collectors and the separator plate, the coating may be relatively non-conductive. Further, where the silane coating is of sufficient thinness to allow sufficient current to pass, the coating may be relatively non-conductive and may fully encapsulate the separator plate, current collector, intermediary support element, or any combination of the three, provided that the combined thickness of the coatings are sufficiently thin as to allow sufficient current to pass. Various methods of bonding and welding the current collector are well established in the art and will be readily apparent to those skilled in the art, given the benefit of this disclosure. For example, a bipolar separator plate that is coated with a relatively non-conductive silane coating may be joined with the current collector by means of ultrasonic welding or thermal welding.

Though fuel cell stacks clearly are scaleable by altering the quantity of cells comprising the stack of cells, it is advantageous to efficiently alter the area of the cells as well. As is well known in the art, cell count determines stack voltage while cell area determines stack current. Particularly advantageous is the fact that the repeated finite sub-sections of the continuously produced bipolar separator plate do not require discontinuity of the electrodes and electrolyte member of the fuel cell. Many of the conventional designs of the prior art bipolar separator designs are quite capable of continuous, progressively tooled, manufacture. However, all prior art designs would require discontinuity of the electrodes and electrolyte members in order to properly fit the resultant repeated finite sub-sections. Many prior art designs are incapable of continuous progressive tooling due to the nature of their fuel, oxidant, and coolant manifolding and flow pattern designs. The structure of the separator plate that creates flow channels and manifolds is stretch-formed into finite sub-sections by what is known in the art as progressive tooling. Progressive tooling is an efficient means to produce complex stampings from a series of low-complexity tools, or, as a means to produce a product whose area is substantially larger than the tool that is utilized. In certain preferred embodiments, bipolar separator plates are produced utilizing progressive tooling. Such plates possess modularity not found in conventional discontinuous bipolar separator plate designs. The scaleable cell area of such a separator plate provides responsiveness to a wider range of fuel cell applications, from residential to light commercial/industrial to automotive, without deviating from the underlying geometries.

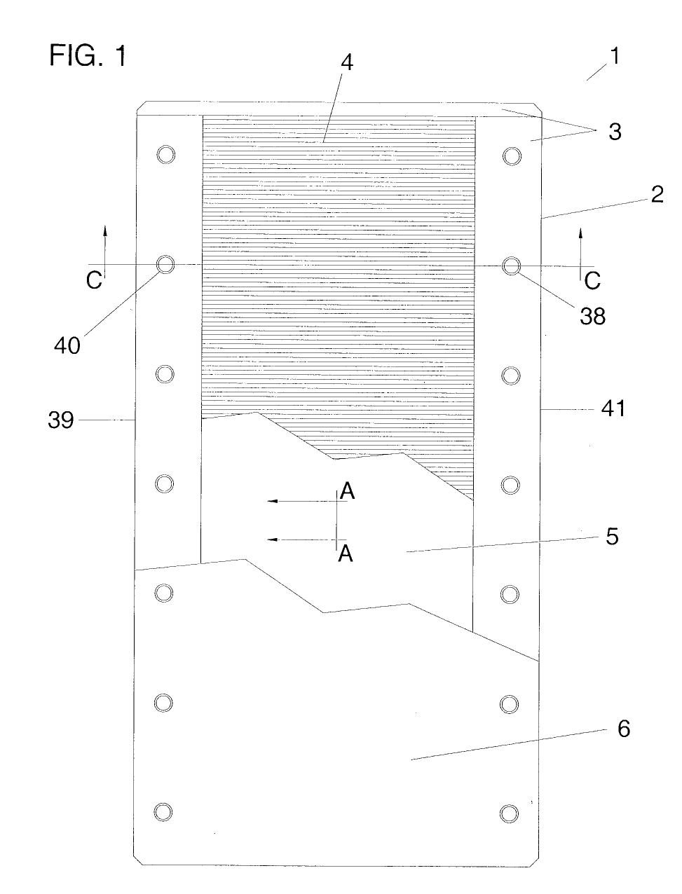

FIG. 1 illustrates a preferred bipolar separator plate that is producible in a variety of lengths as described in related U.S. patent application Ser. No. 09/714,526, filed Nov. 16, 2000, titled “Fuel Cell Bipolar Separator Plate and Current Collector Assembly and Method of Manufacture” and incorporated in entirety herein by reference. It will be understood that the discussion of the bipolar separator plate is exemplary and would be equally applicable to any of the metallic fuel cell components. The plate 1, being constructed from metallic foil 2, is desirable for application to low temperature fuel cells utilizing Proton Exchange Membranes (PEM's) 6. Metallic foils 2 are easily processed with conventional tools to produce the necessary mechanical structure and architecture within the plate 1. Proton Exchange Membrane 6 is preferably comprised of a perfluorinated sulfonic acid polymer such as, for example, NAFION, a product of E. I. Dupont De Nemours. Such membranes are fully fluorinated TEFLON-based polymers with chemically bonded sulfonic acid groups. The membranes 6 typically exhibit exceptionally high chemical and thermal stability. Without wishing to be bound by theory, it is presently believed that some metallic alloys that are commercially and economically viable candidates for making up the bipolar separator plate may be subject to corrosion if the alloy comes in contact with a perfluorinated sulfonic acid polymer membrane material or other corrosive material. The corrosion of the bipolar separator plate generally leads to higher electronic resistivity of the fuel cell and subsequently to lower power output from the fuel cell. Undesirable corrosion of the metallic foil can further result in the subsequent liberation of corrosion product from the metal foil, for example, in the form of metallic cations such as Fe⁺² and the like. Such liberated metallic cations may then migrate to the membrane 6 and contaminate the sulfonic acid groups that promote the transport of hydrogen ions during operation of the fuel cell, thus diminishing the performance of the PEM and thus of the fuel cell.

The corrosion of the metallic bipolar separator plate and possible contamination of the PEM, for example, by the liberation and subsequent migration of cations, is preventable by the application of a coating to the metallic foil 2 comprising the plate 1. One function of the coating is to eliminate the ability of the separator plate to contact the PEM, thereby reducing or eliminating the liberation of cations from the metallic plate and subsequent migration of those cations to the PEM. At the same time, the coating allows satisfactory electrical conductivity from the bipolar separator plate 1 to the membrane 6 to achieve the desired operating conditions and power output. Satisfactory resistivity may typically range from about 10 mohm cm² to about 50 mohm/cm².

The coating in certain preferred embodiments may be applied only to those areas of the bipolar separator plate that are in intimate contact with, or close proximity to, the NAFION membrane 6. Again, as used herein, the term “close proximity” refers to portions of the plate that are close enough to the PEM to be corroded by the PEM. For example, the seal area 3 at the perimeter of the bipolar separator plate 1 where the membrane 6 forms a seal between adjacent bipolar separator plates that separate adjacent cells in a stack of cells forming a fuel cell stack.

The coating may further be applied to the entire area of the metallic substrate comprising the bipolar separator plate to further enhance the encapsulation of the metal. In a preferred embodiment the peaks and valleys comprising the flow channels of the central active area 4 of the bipolar separator plate 1 are coated prior to the final forming and assembly of the bipolar plate while the stamped plates remain attached to the coil of metal foil 2 from which they were formed. This technique is known in the art as coil coating.

However, an electrical contact is required at the interface of the peaks of the flow channels of the plate 1 and the diffusion layer 5 that is shown partially cut away. The diffusion layer 5 is comprised of porous carbon fiber paper that is electrically conductive. Electric current generated at the reaction sites of the membrane electrode assembly 6 is gathered by the diffusion layer 5 and transmitted through the bipolar separator plates 1 of adjacent cells of a stack of cells to the terminals normally positioned at the ends of the stack of cells. Therefore, the interface between the peaks of the flow channels of the central active area 4 and the diffusion layer 5 must be conductive.

The conductivity of the interface of the coated peaks and the diffusion layer 5 may be achieved without violation of the integrity of the encapsulating coating if the coating is conductive.

In a preferred embodiment, the coating for the metallic bipolar separator plate 1 comprises a silane. Without wishing to be bound by theory, it is presently believed that the silane coatings are capable of serving several purposes. First, the coating may serve to form a barrier that prohibits acid from reaching the surface of the separator plate and causing contamination and that prevents material from leaving the surface of the separator plate. Second, since perfluorinated sulfonic acid polymer membranes loses conductivity when contaminated by cations and stainless steel contains a variety of metals (Fe, Mo, V, Cr, etc.) that can be released as cations upon the steel corroding, a coating on the stainless steel can trap these cations, perhaps by complexing with the cations, before they get to the perfluorinated sulfonic acid polymer membrane. In particular, silanes such as 3-aminopropyltriethoxysilane and N-(2-aminoethyl)-3-aminopropyltrimethoxysilane would provide secondary as well as primary amines to react with cations. Additionally, the silane coating may serve to permit transfer of electrons and protons, e.g., hydrogens, while prohibiting the passage of larger ions to and from the separator plate surface, thus acting as a type of selective membrane or coating, that is, allowing selective transport of electrons and protons. It is known that certain silanes can move about the surface to which they are attached. As such, it is possible that silanes of this type could form a self-repairing coating, that is, they may re-cover areas that have had the coating removed as from scratches during assembly, usage and the like. Finally, the silane coatings may serve to prepare or treat the surface of the separator plate such that an additional coating, such as a polymer coating, will adhere to the separator plate, possibly by acting as an adhesive.

Certain preferred silanes include methyltrimethoxysilane, octadecyltrimethoxysilane, 3-aminopropyltriethoxysilane, N-(2-aminoethyl)-3-aminopropyltrimethoxysilane, and methyldimethoxysilane. Methyltrimethoxysilane is a simple small silane molecule that will provide a hydrophobic surface that has may pass a high level of current along with high durability and low cost. Octadecyltrimethoxysilane is a silane that has a long hydrophobic hydrocarbon chain. 3-aminopropyltriethoxysilane is a common silane that can react with acids to form salts, dissolves in water, and reacts rapidly with surface hydroxyl groups. This molecule will hold an electric charge that is close to the metal surface. N-(2-aminoethyl)-3-aminopropyltrimethoxysilane has similar properties to the 3-aminopropyltriethoxysilane and in addition may be able to complex cations. Methyldimethoxysilane is a silane that is used as a primer coat for many other materials. This silane forms an OH group directly on Si and so might be a superior conductor as well as a barrier. These and other suitable silanes are commercially available, and it will be readily apparent, from the above description and through routine experimentation, for one of ordinary skill in the art to select these and other suitable silanes for use in any given application, given the benefit of this disclosure.

In a preferred embodiment, treatment of the stainless steel coil with acid, for example, hot concentrated sulfuric acid, is desired in order to remove loose anions or cations prior to application of coatings. Surface preparation may also include the use of solvents like hot xylenes and/or isopropanol. In a preferred embodiment, an acid treatment, water wash, and final isopropanol treatment meets most needs for surface treatment of the stainless steel bipolar plate 1. This treatment makes the surfaces ready to receive the silane coatings. Preferred procedures will minimize human exposure to corrosive and or toxic materials, remove loose cations from the stainless steel surface, remove dirt and grease from the surface, and prepare the surface for quality uniform coating with silanes.

In certain preferred embodiments, the coating is applied only to those areas of the separator plate that are in intimate contact with, or close proximity to, the proton exchange membrane. Such areas include, for example, the seal area at the perimeter of the bipolar separator plate where the membrane forms a seal between adjacent bipolar separator plates that separate adjacent cells in a stack of cells forming a fuel cell stack. The coating may alternatively be applied to the entire surface area of the separator plate to further enhance the encapsulation of the plate material. In certain preferred embodiments, the peaks and valleys comprising the flow channels of the central active area of the bipolar separator plate are coated with a coating comprising a silane prior to the final forming and assembly of the bipolar separator plate.

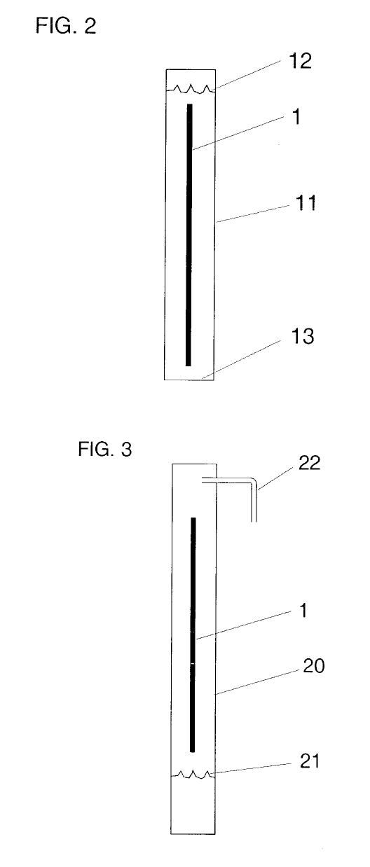

Certain preferred embodiments provide surface treatments for the surfaces of the separator plates that are designed for batch operation. Preferably, the separator plates comprise stainless steel. It is expected that a person skilled in coil treating can apply these processes to coils of stainless steel, such as, for example, in a continuous process. These procedures are advantageously applied to separator plates comprising stainless steel that is highly resistant to hot concentrated sulfuric acid. Special process concerns center around ensuring the personal safety of those employing the method, and the method is generally employed utilizing apparatus designed to address this issue. For example, the treating vessel 11 shown in FIG. 2. has a small liquid surface to minimize human exposure and to help insure that the exact time, temperatures and concentrations are achieved. Other suitable treating apparatus will be readily apparent to those of skill in the art, given the benefit of the present disclosure.

In certain preferred embodiments, the separator plate or coil that will be made into the separator plate is treated prior to coating with acid, for example, sulfuric acid, preferably 50% to 80% technical grade sulfuric acid 12. Generally, the treatment will be performed by immersing the plate or coil in the acid, preferably in hot or heated acid. Immersion times and temperatures will be readily determined by one skilled in the art, given the benefit of the present disclosure. For example, an immersion time of one minute, at 95° C., will typically adequately treat the surfaces of most separator plates. Advantageously, the separator plate or coil is then washed in distilled water, preferably deionized, demineralized distilled water, optionally followed by a vapor phase water rinse, such as is shown in FIG. 3, where distilled water 21 is heated in vessel 20. Water vapor will condense on plate or coil 1 and rinse the surface of the plate. Excess vapor may exit via tube 22. In other preferred embodiments, the separator plate or coil that will be made into the separator plate is treated prior to coating with one or more treating solvents, preferably selected from the group consisting of xylene, isopropanol and mixtures of the two. The treatment may be performed by immersing the plate or coil into the treating solvent, or advantageously may be performed by subjecting the plate or coil to a vapor of the treating solvent. Preferably, the treatment with the treating solvent follows treatment with the acid and water and optional water vapor. Optionally, the same apparatus used for the acid/water treatment can be used for the isopropanol final vapor phase cleaning and drying. Without wishing to be bound by theory, such treatments are thought to remove ions, such as cations that might otherwise contaminate the PEM, from the surfaces of the separator plate material and to clean and degrease the surfaces of the separator plate material, creating a cleaner surface for coating with the silane-comprising coating. Additional embodiments for treatment of the plate or coil surfaces include sand blasting with silica, degreasing and oxidizing with H₂O₂ either alone or in combination with nitric acid (HNO₃), combining silica sand blasting with added chemicals, such as, for example, SiO₂ with SiI₄, hot concentrated acid such as sulfuric acid, nitric acid and the like, etc. Other suitable treating compositions and methods will be readily apparent to those of skill in the art, given the benefit of the present disclosure.

Process options include cutting the bipolar separator plate from the coil of sheet metal just prior or just after the final cleaning with isopropanol or just before or just after the silane-treating step. Optionally, fuel cells may be assembled immediately after the silane-treating step is completed.

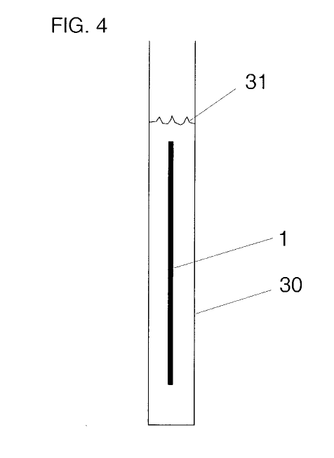

Once the treatment has taken place, the cleaned surfaces of the separator plate or coil that will be made into the separator plate is preferably not touched or handled, and the plate is coated, or the coil is assembled into the plate and then coated, immediately after the treatment process. The silane coatings in certain preferred embodiments can be applied by various means known to be effective in the coating of metallic substrates, such as, for example, coating methods commonly utilized in the coating of continuous strips of metal sheets and foils as commonly applied in the coil coating industry. Exemplary coating methods include spray coating, dip coating, roll coating, and the like. A preferred embodiment apparatus for silane coating is shown in FIG. 4 and includes use of a vessel 30 containing silane coating liquid 31 and plate or coil 1. Suitable immersion times and temperatures will be readily determinable by one of skill in the art, given the benefit of this disclosure. In certain preferred embodiments, the plate or coil is immersed for one minute at room temperature and subsequently removed and air-dried. Other suitable coating methods will be readily apparent to one skilled in the art, given the benefit of this disclosure.

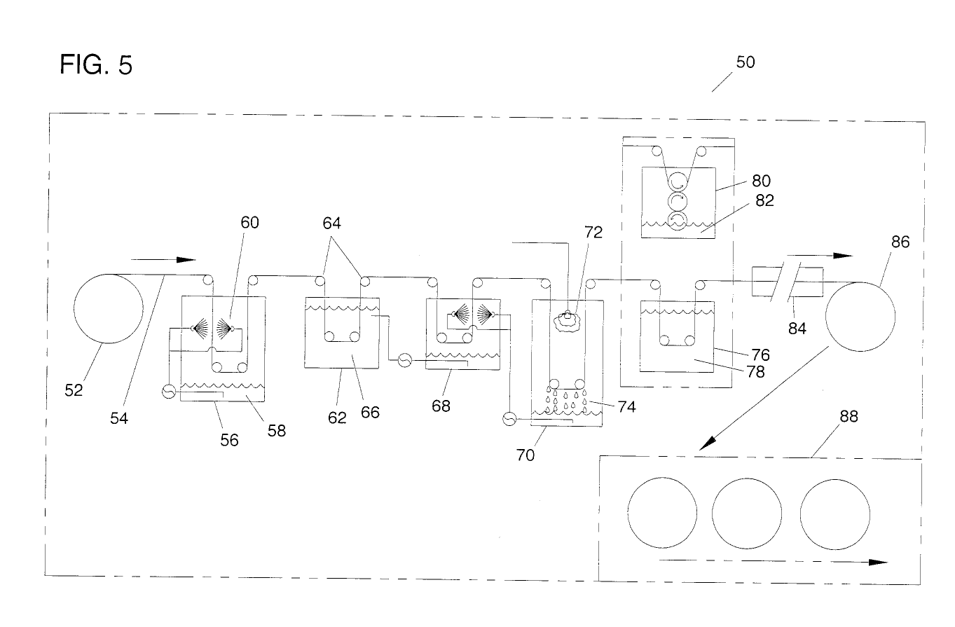

In certain preferred embodiments, as are illustrated in FIG. 5, a coil-coating apparatus 50 is utilized to apply coatings to a coil. The coil may have been stamped with features that create bipolar plates within the coil. The coil may alternatively be a coil of current collector, or of any other fuel cell component suitable for such construction. A feed coil 52 comprises a strip 54 of metal that is fed through a first tank 56 containing acid 58 for cleaning the surfaces of the strip 54. The acid 58 may be applied to the strip 54 by spray heads 60. The strip 54 is further directed to a first rinse tank 62 by guide rolls 64. First rinse tank 62 contains water 66 delivered from adjacent second rinse tank 68. Second rinse tank 68 further rinses strip 54 with water 66 delivered from third rinse tank 70. Third rinse tank 70 utilizes steam 72 that is condensed on strip 54 forming condensate water 74. The strip is further directed to first treating tank 76 containing coating 78 to coat both surfaces of strip 54. Alternatively, strip 54 is directed to second treating tank 80 containing coating 82 to coat one side of strip 54, or a partial area of strip 54. The coatings 78, 82 on strip 54 may be further cured in drying chamber 84 and the strip 54 may optionally then be re-coiled on take-up coil 86. Alternatively, the strip 54 is re-coiled on take-up coil 86 and take-up coil 86 may be cured in storage area 88.

The following are examples of suitable silane coating solutions and coating methods. Each such formulation could be used to coat a plate or coil by the methods provided below or by any of the coating methods disclosed herein. For small scale operations, distilled white vinegar can be substituted for the 5% acetic acid solution.

### EXAMPLE 1

| | | % by volume |
|---|---|---|
| Component Class | Component | of the solution |
| Silane | Methyltrimethoxysilane or N-(2- | 2 |
| | aminoethyl)-3- | |
| | aminopropyltrimethoxysilane | |
| Acid | Acetic acid solution, 5% in | 5 |
| | water | |
| Solvent | Isopropanol | 10 |
| Water | demineralized, deionized | 83 |
| | distilled water | |

In a first vessel, add the acetic acid solution to the water with stirring. In a second vessel, add the silane to the isopropanol with stirring. Add the isopropanol/silane solution to the water/acid solution with stirring to form the silane coating solution. Submerge the cleaned stainless steel plate into the silane coating solution, ensuring that all air bubbles are gone from the surface to ensure complete coating. Remove the plate and allow it to dry.

### EXAMPLE 2

| Component | | |
|---|---|---|
| Class | Component | % by volume of the solution |
| Silane | Methyltrimethoxysilane | 2 |
| Acid | Acetic acid solution, 5% in | 5 |
| | water | |
| Solvent | Isopropanol | 80 |
| Water | demineralized, deionized | 13 |
| | distilled water | |

In a first vessel, add the acetic acid to the water with stirring. In a second vessel, add the silane to the isopropanol with stirring. Combine the isopropanol/silane solution to the water/acid solution with stirring to form the silane coating solution. Submerge the cleaned stainless steel plate into the silane coating solution, ensuring that all air bubbles are gone from the surface to ensure complete coating. Remove the plate and allow it to dry.

### EXAMPLE 3

| Component | | |
|---|---|---|
| Class | Component | % by volume of the solution |
| Silane | Octadecyltrimethoxysilane | 2 |
| | or Methyldimethoxysilane | |
| Solvent | pure bone-dry toluene or | 98 |
| | xylene | |

Add the silane to the solvent with stirring to form the silane coating solution. Submerge the cleaned stainless steel plate into the silane coating solution, ensuring that all air bubbles are gone from the surface to ensure complete coating. Remove the plate and allow it to dry. Following coating the plate or coil, extra time for drying must be allowed because of the low volatility of the toluene or xylene solvents. After drying, allow 2 days exposure to a humid atmosphere for curing the coating.

### EXAMPLE 4

| Component | | % |
|---|---|---|
| Class | Component | by volume of the solution |
| Silane | 3-Aminopropyltriethoxysilane | 2 |
| Acid | Acetic acid solution, 5% in | 1 |
| | water | |
| Water | demineralized, deionized | 97 |
| | distilled water | |

Add the acetic acid to the water with stirring then add the silane slowly with constant stirring to form the silane coating solution. Submerge the cleaned stainless steel plate into the silane coating solution, ensuring that all air bubbles are gone from the surface to ensure complete coating. Remove the plate and allow it to dry.

While various preferred embodiments of the methods and devices have been illustrated and described, it will be appreciated that various modifications and additions can be made to such embodiments without departing from the spirit and scope of the methods and devices as defined by the following claims.

We claim:

1. A metallic fuel cell component for low temperature fuel cells utilizing proton exchange membranes, wherein the metallic fuel cell component is at least partially coated with a coating comprising a silane.

2. The metallic fuel cell component of claim 1, wherein the coating is stable when in contact with or in close proximity to a proton exchange membrane and within anode and cathode environments of a fuel cell.

3. The metallic fuel cell component of claim 1, wherein the coating comprises a silane having the formula:
(RO)_{P}SiR′_{N}R″_{M}
where P+N+M=4 and P=2 or 3;
R=CH₃— or CH₃CH₂—
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H where R′=CH₃—

4. The metallic fuel cell component of claim 1, wherein the silane is selected from the group consisting of methyltrimethoxysilane, octadecyltrimethoxysilane, 3-aminopropyltriethoxysilane, N-(2-aminoethyl)-3-aminopropyltrimethoxysilane, and methyldimethoxysilane.

5. The metallic fuel cell component of claim 1, wherein the coating comprises a silane having the formula:
(RO)_{P}SiR′_{N}R″_{M}
where P+N+M=4 and P=1, 2 or 3;
R=CH₃(CH₂)ₙ—,
where n=0-18;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H

6. The metallic fuel cell component of claim 1, wherein the coating comprises a silane having the formula:
(RO)_{P}SiR′_{N}R″_{M}
where P+N+M=4 and P=1, 2 or 3;
R=CH₃CO—, ethoxyethyl or ethoxybutyl;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1
R″=H

7. The metallic fuel cell component of claim 1, wherein the coating comprises a silane having the formula:
ClₓSiR_{y}
where y=1, 2 or 3 and x=4−y; and
R=CH₃—, CH₃CH₂—, H, or CH₃(CH₂)ₙ— where n=2-18.

8. The metallic fuel cell component of claim 1, wherein the coating comprises a silane having the formula:
(RO)_{P}SiR′_{N}R″_{M}
where P+N+M=4 and P=1, 2 or 3;
R=linear or branched alkyl groups of 1-19 carbons, cycloalkyl groups of 3-19 carbons, or alkyl aromatic groups;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H.

9. The metallic fuel cell component of claim 1, wherein the coating comprises a silane containing at least one acylamino silane linkage and at least one alkene or arylene group.

10. The metallic fuel cell component of claim 9, wherein the silane is selected from the group consisting of gamma-ureidopropyltriethoxysilane, gamma-acetylaminopropyltriethoxysilane and delta-benzoylaminobutylmethyldiethoxysilane.

11. The metallic fuel cell component of claim 9, wherein the silane is a ureido silane.

12. The metallic fuel cell component of claim 11, wherein the silane is gamma-ureidopropyltriethoxysilane.

13. The metallic fuel cell component of claim 1, wherein the coating comprises a silane containing at least one cyano silane linkage and at least one alkene or arylene group.

14. The metallic fuel cell component of claim 13, wherein the silane is selected from the group consisting of cyanoeethyltrialkoxysilane, cyanopropytri-alkoxysilane, cyanoisobutyltrialoxysilane, 1-cyanobutyltrialkoxysilane, 1-cyanoisobutyltrialkoxysilane and cyanophenyltrialkoxysilane.

15. The metallic fuel cell component of claim 1, wherein the silane comprises a mercaptosilane.

16. The metallic fuel cell component of claim 15, wherein the mercaptosilane comprises a mercaptosilane of the formula:
(RO)_{c}SiR′_{d}R″ₑR′″_{f}
where c+d+e+f=4;
c=1, 2 or 3;
R=CH₃(CH₂)_{g}, where g=0-17 and R may be linear or branched; CH₃(CH₂)₁—O—CH₂(CH₂)ᵢ, where h=0-4 and i=1, 2 or 3;
R′=—CH₂CH₂CH₂SH
R″=R′, H, or CH₃(CH₂)_{g}, where g=0-17 and R may be linear or branched; and
R′″=R″.

17. The metallic fuel cell component of claim 15, wherein the mercaptosilane comprises a mercaptosilane of the formula:

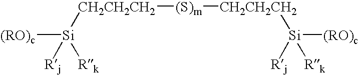

18. The metallic fuel cell component of claim 15, wherein the silane is selected from the group consisting of 3-glycidoxypropyltrimethoxysilane, 3-mercaptopropyltrimethoxysilane, 2-mercaptoethyltrimethoxysilane, 2-(3,4-epoxycyclohexyl)-ethyltrimethoxysilane, and partial hydrolyzates thereof.

19. The metallic fuel cell component of claim 1, wherein the silane comprises a tetrafunctional silane.

20. The metallic fuel cell component of claim 19, wherein the coating comprises between about 0.5% and about 20% by weight of the dried coating of tetrafunctional silane.

21. The metallic fuel cell component of claim 19, wherein the coating comprises between about 2% and about 5% by weight of the dried coating of tetrafunctional silane.

22. The metallic fuel cell component of claim 19, wherein the tetrafunctional silane comprises a tetraalkoxysilane.

23. The metallic fuel cell component of claim 19, wherein the tetrafunctional silane is selected from the group consisting of tetramethoxysilane, tetraethoxysilane and tetra-n-butoxysilane.

24. The metallic fuel cell component of claim 1, wherein the silane comprises a vinyl-polymerizable unsaturated hydrolizble silane.

25. The metallic fuel cell component of claim 24, wherein the vinyl-polymerizable unsaturated hydrolizble silane contains at least one silicon-bonded hydrolizable group.

26. The metallic fuel cell component of claim 25, wherein the silicon-bonded hydrolizable group is selected from the group consisting of alkoxy, halogen and aryloxy.

27. The metallic fuel cell component of claim 24, wherein the vinyl-polymerizable unsaturated hydrolizble silane contains at least one silicon-bonded vinyl-polymerizable unsaturated group.

28. The metallic fuel cell component of claim 27, wherein the vinyl-polymerizable unsaturated hydrolizble silane is selected from the group consisting of gamma-methacryloxypropyltrimethoxysilane, gamma-acryloxypropyltriethoxysilane, vinyltri(2-methoxyethoxy) silane, vinyltrimethoxysilane, vinyltriethoxysilane, vinyltrichlorosilane, vinyltriacetoxysilane, ethynytrimethoxysilane, ethynytriethoxysilane 2-propynyltrimethoxysilanesilane, 2-propynyltriethoxysilanesilane and 2-propynyltrichlorosilane.

29. The metallic fuel cell component of claim 1, wherein the silane comprises a vinyl-polymerizable unsaturated hydrolizble silane of the formula:
RₐSi(RO)_{b}Y_{c}
wherein R is a monovalent hydrocarbon group;
(RO) is a silicon-bonded hydrolyzable group;
Y is a silicon-bonded monovalent organic group containing at least one vinylpolymerizable unsaturated bond;
a is 0, 1 or 2;
b is 1, 2 or 3;
c is 1, 2 or 3;
and a+b+c=4.

30. The metallic fuel cell component of claim 29, wherein the monovalent hydrocarbon group is selected from the group consisting of methyl, ethyl, propyl, isopropyl, butyl, pentyl, isobutyl, isopentyl, octyl, decyl, cyclohexyl, cyclopentyl, benzyl, phenyl, phenylethyl and naphthyl and their isomers.

31. The metallic fuel cell component of claim 1, wherein the silane comprises a relatively low molecular weight vinyl-polymerizable unsaturated polysiloxane oligomer.

32. The metallic fuel cell component of claim 31, wherein the relatively low molecular weight vinyl-polymerizable unsaturated polysiloxane oligomer is of the formula:
R_{g}(R_{d}Y_{2-d}SiO)ₑ(R₂SiO)_{f}(SiR₃)_{g}
where R is a monovalent hydrocarbon group;
Y is a silicon-bonded monovalent organic group containing at least one vinylpolymerizable unsaturated bond;
d is 0 or 1;
e is 1, 2, 3 or 4;
f is 0, 1, 2 or 3;
g is 0 or 1;
e+f+g is equal to an integer of 1 to 5;
and d can be the same or different in each molecule.

33. The metallic fuel cell component of claim 31, wherein the relatively low molecular weight vinyl-polymerizable unsaturated polysiloxane oligomer is a cyclic trimer, a cyclic tetramer a linear dimer, a linear trimer, a linear tetramer or a linear pentamer.

34. The metallic fuel cell component of claim 1, wherein the silane is 2-(3,4-epoxycyclohexyl)-ethyltrimethoxysilane.

35. A metallic fuel cell component for low temperature fuel cells utilizing proton exchange membranes, wherein the plate is at least partially coated with a coating comprising a silazane.

36. The metallic fuel cell component of claim 35, wherein the silazane comprises polysilazane.

37. The metallic fuel cell component of claim 35, wherein the silazane comprises hexamethyldisilazane.

38. The metallic fuel cell component of claim 1, wherein the metallic fuel cell component is a bipolar separator plate.

39. The metallic fuel cell component of claim 38, wherein the bipolar separator plate comprises metal foil.

40. The metallic fuel cell component of claim 39, wherein the bipolar separator plate comprises stainless steel.

41. The metallic fuel cell component of claim 1, wherein the metallic fuel cell component is a current collector.

42. The metallic fuel cell component of claim 41, wherein the current collector comprises flat metallic wires.

43. The metallic fuel cell component of claim 42, wherein the current collector comprises stainless steel.

44. The metallic fuel cell component of claim 1, wherein the metallic fuel cell component is entirely coated with the coating.

45. The metallic fuel cell component of claim 1, wherein the metallic fuel cell component is partially coated with the coating.

46. The metallic fuel cell component of claim 1, wherein the metallic fuel cell component is coated only at areas that are in intimate contact with or close proximity to a proton exchange membrane when the metallic fuel cell component is incorporated into a fuel cell comprising the proton exchange membrane.

47. The metallic fuel cell component of claim 1, wherein the metallic fuel cell component is further coated with an additional coating.

48. The metallic fuel cell component of claim 47, wherein the additional coating comprises a polymer.

49. The metallic fuel cell component of claim 48, wherein the polymer is a conductive polymer.

50. The metallic fuel cell component of claim 48, wherein the polymer is a non-conductive polymer.

51. The metallic fuel cell component of claim 48, wherein the coating comprising a silane serves to adhere the additional coating to the metallic fuel cell component.

52. The metallic fuel cell component of claim 48, wherein the coating comprising a silane serves to treat the metallic fuel cell component for acceptance of the additional coating.

53. The metallic fuel cell component of claim 48, wherein the coating comprising a silane is sandwiched between the metallic fuel cell component and the additional coating.

54. The metallic fuel cell component of claim 1, wherein the silane is of the formula:
(RO)ₘSiR′ₙR″ₒR′″ₚ
where m+n+o+p=4 and m=1, 2 or 3;
R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4;
R′=CH₃—; CH₃(CH₂)_{q}—, where q=1-18 and the alkyl structure can be linear or branched; or —CH₂CH₂CH₂—Z,
where Z=NH₂, CN, Cl, SH, H, 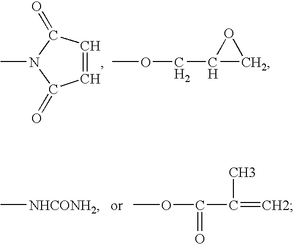
R″=R′ or R″; and
R′″=R″.

55. The metallic fuel cell component of claim 1, wherein the silane is of the formula:
ClₘSiR′ₙR″ₒR′″ₚ
where m+n+o+p=4 and m=1, 2 or 3;
R′=CH₃—; CH₃(CH₂)_{q}—, where q=1-18 and the alkyl structure can be linear or branched; or —CH₂CH₂CH₂—Z,
where Z=NH₂, CN, Cl, SH, H, or 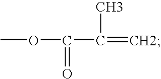
R″=H or R′
R′″=R″.

56. The metallic fuel cell component of claim 1, wherein the silane is of the formula:
(CH₃)₃Si—NH—Si(CH₃)₃.

57. The metallic fuel cell component of claim 1, wherein the silane is of the formula: 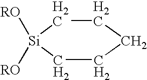
where R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4.

58. A fuel cell comprising a metallic fuel cell component and a proton exchange membrane, wherein the metallic fuel cell component is at least partially coated with a coating comprising a silane.

59. The fuel cell of claim 58, wherein the coating is stable when in contact with or in close proximity to a proton exchange membrane and within anode and cathode environments of a fuel cell.

60. The fuel cell of claim 58, wherein the coating comprises a silane having the formula:
(RO)_{P}SiR′_{N}R″_{M}
where P+N+M=4 and P=2 or 3;
R=CH₃— or CH₃CH₂—
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1
R″=H

61. The fuel cell of claim 58, wherein the silane is selected from the group consisting of methyltrimethoxysilane, octadecyltrimethoxysilane, 3-aminopropyltriethoxysilane, N-(2-aminoethyl)-3-aminopropyltrimethoxysilane, and methyldimethoxysilane.

62. The fuel cell of claim 58, wherein the coating comprises a silane having the formula:
(RO)_{P}SiR′_{N}R″_{M}
where P+N+M=4 and P=1, 2 or 3;
R=CH₃(CH₂)ₙ—,
where n=0-18;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H

63. The fuel cell of claim 58, wherein the coating comprises a silane having the formula:
(RO)_{P}SiR′_{N}R″_{M}
where P+N+M=4 and P=1, 2 or 3;
R=CH3CO—, ethoxyethyl or ethoxybutyl;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1
R″=H

64. The fuel cell of claim 58, wherein the coating comprises a silane having the formula:
ClₓSiR_{y}
where y=1, 2 or 3 and x=4−y; and
R=CH₃—, CH₃CH₂—, H, or CH₃(CH₂)ₙ— where n=2-18.

65. The fuel cell of claim 58, wherein the coating comprises a silane having the formula:
(RO)_{P}SiR′_{N}R″_{M}
where P+N+M=4 and P=1, 2 or 3;
R=linear or branched alkyl groups of 1-19 carbons, cycloalkyl groups of 3-19 carbons, or alkyl aromatic groups;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H

66. The fuel cell of claim 58, wherein the coating comprises a silane containing at least one acylamino silane linkage and at least one alkene or arylene group.

67. The fuel cell of claim 66, wherein the silane is selected from the group consisting of gamma-ureidopropyltriethoxysilane, gamma-acetylaminopropyltriethoxysilane and delta-benzoylaminobutylmethyldiethoxysilane.

68. The fuel cell of claim 66, wherein the silane is a ureido silane.

69. The fuel cell of claim 68, wherein the silane is gamma-ureidopropyltriethoxysilane.

70. The fuel cell of claim 58, wherein the coating comprises a silane containing at least one cyano silane linkage and at least one alkene or arylene group.

71. The fuel cell of claim 70, wherein the silane is selected from the group consisting of cyanoeethyltrialkoxysilane, cyanopropytri-alkoxysilane, cyanoisobutyltrialoxysilane, 1-cyanobutyltrialkoxysilane, 1-cyanoisobutyltrialkoxysilane and cyanophenyltrialkoxysilane.

72. The fuel cell of claim 58, wherein the silane comprises a mercaptosilane.

73. The fuel cell of claim 72, wherein the mercaptosilane comprises a mercaptosilane of the formula:
(RO)_{c}SiR′_{d}R″ₑR′″_{f}
where c+d+e+f=4;
c=1, 2 or 3;
R=CH₃(CH₂)_{g}, where g=0-17 and R may be linear or branched; CH₃(CH₂)ₕ—O—CH₂(CH₂)ᵢ, where h=0-4 and i=1, 2 or 3;
R′=—CH₂CH₂CH₂SH
R″=R′, H, or CH₃(CH₂)_{g}, where g=0-17 and R may be linear or branched; and
R′″=R″.

74. The fuel cell of claim 72, wherein the mercaptosilane comprises a mercaptosilane of the formula: 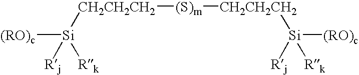
where c=1 or 2;
c+j+k=3; and
m=1 to 4.

75. The fuel cell of claim 72, wherein the silane is selected from the group consisting of 3-glycidoxypropyltrimethoxysilane, 3-mercaptopropyltrimethoxysilane, 2-mercaptoethyltrimethoxysilane, 2-(3,4-epoxycyclohexyl)-ethyltrimethoxysilane, and partial hydrolyzates thereof.

76. The fuel cell of claim 58, wherein the silane comprises a tetrafunctional silane.

77. The fuel cell of claim 76, wherein the coating comprises between about 0.5% and about 20% by weight of the dried coating of tetrafunctional silane.

78. The fuel cell of claim 76, wherein the coating comprises between about 2% and about 5% by weight of the dried coating of tetrafunctional silane.

79. The fuel cell of claim 76, wherein the tetrafunctional silane comprises a tetraalkoxysilane.

80. The fuel cell of claim 19, wherein the tetrafunctional silane is selected from the group consisting of tetramethoxysilane, tetraethoxysilane and tetra-n-butoxysilane.

81. The fuel cell of claim 58, wherein the silane comprises a vinyl-polymerizable unsaturated hydrolizble silane.

82. The fuel cell of claim 81, wherein the vinyl-polymerizable unsaturated hydrolizble silane contains at least one silicon-bonded hydrolizable group.

83. The fuel cell of claim 82, wherein the silicon-bonded hydrolizable group is selected from the group consisting of alkoxy, halogen and aryloxy.

84. The fuel cell of claim 81, wherein the vinyl-polymerizable unsaturated hydrolizble silane contains at least one silicon-bonded vinyl-polymerizable unsaturated group.

85. The fuel cell of claim 84, wherein the vinyl-polymerizable unsaturated hydrolizble silane is selected from the group consisting of gamma-methacryloxypropyltrimethoxysilane, gamma-acryloxypropyltriethoxysilane, vinyltri(2-methoxyethoxy) silane, vinyltrimethoxysilane, vinyltriethoxysilane, vinyltrichlorosilane, vinyltriacetoxysilane, ethynytrimethoxysilane, ethynytriethoxysilane 2-propynyltrimethoxysilanesilane, 2-propynyltriethoxysilanesilane and 2-propynyltrichlorosilane.

86. The fuel cell of claim 58, wherein the silane comprises a vinyl-polymerizable unsaturated hydrolizble silane of the formula:
RₐSiX_{b}Y_{c}
wherein R is a monovalent hydrocarbon group;
X is a silicon-bonded hydrolyzable group;
Y is a silicon-bonded monovalent organic group containing at least one vinylpolymerizable unsaturated bond;
a is 0, 1 or 2;
b is 1, 2 or 3;
c is 1, 2 or 3;
and a+b+c=4.

87. The fuel cell of claim 86, wherein the monovalent hydrocarbon group is selected from the group consisting of methyl, ethyl, propyl, isopropyl, butyl, pentyl, isobutyl, isopentyl, octyl, decyl, cyclohexyl, cyclopentyl, benzyl, phenyl, phenylethyl and naphthyl and their isomers.

88. The fuel cell of claim 58, wherein the silane comprises a relatively low molecular weight vinyl-polymerizable unsaturated polysiloxane oligomer.

89. The fuel cell of claim 88, wherein the relatively low molecular weight vinyl-polymerizable unsaturated polysiloxane oligomer is of the formula:
R_{g}(R_{d}Y_{2-d}SiO)ₑ(R₂SiO)_{f}(SiR₃)_{g}
where R is a monovalent hydrocarbon group;
Y is a silicon-bonded monovalent organic group containing at least one vinylpolymerizable unsaturated bond;
d is 0 or 1;
e is 1, 2, 3 or 4;
f is 0, 1, 2 or 3;
g is 0 or 1;
e+f+g is equal to an integer of 1 to 5;
and d can be the same or different in each molecule.

90. The fuel cell of claim 88, wherein the relatively low molecular weight vinyl-polymerizable unsaturated polysiloxane oligomer is a cyclic trimer, a cyclic tetramer a linear dimer, a linear trimer, a linear tetramer or a linear pentamer.

91. The fuel cell of claim 58, wherein the silane is 2-(3,4-epoxycyclohexyl)-ethyltrimethoxysilane.

92. A fuel cell for low temperature fuel cells utilizing proton exchange membranes, wherein the plate is at least partially coated with a coating comprising a silazane.

93. The fuel cell of claim 92, wherein the silazane comprises polysilazane.

94. The fuel cell of claim 92, wherein the silazane comprises hexamethyldisilazane.

95. The fuel cell of claim 58, wherein the metallic fuel cell component is a bipolar separator plate.

96. The fuel cell of claim 95, wherein the bipolar separator plate comprises metal foil.

97. The fuel cell of claim 96, wherein the bipolar separator plate comprises stainless steel.

98. The fuel cell of claim 58, wherein the metallic fuel cell component is a current collector.

99. The fuel cell of claim 98, wherein the current collector comprises flat metallic wires.

100. The fuel cell of claim 99, wherein the current collector comprises stainless steel.

101. The fuel cell of claim 58, wherein the metallic fuel cell component is entirely coated with the coating.

102. The fuel cell of claim 58, wherein the metallic fuel cell component is partially coated with the coating.

103. The fuel cell of claim 58, wherein the metallic fuel cell component is coated only at areas that are in intimate contact with or close proximity to a proton exchange membrane when the metallic fuel cell component is incorporated into a fuel cell comprising the proton exchange membrane.

104. The fuel cell of claim 58, wherein the metallic fuel cell component is further coated with an additional coating.

105. The fuel cell of claim 104, wherein the additional coating comprises a polymer.

106. The fuel cell of claim 105, wherein the polymer is a conductive polymer.

107. The fuel cell of claim 105, wherein the polymer is a non-conductive polymer.

108. The fuel cell of claim 105, wherein the coating comprising a silane serves to adhere the additional coating to the metallic fuel cell component.

109. The fuel cell of claim 105, wherein the coating comprising a silane serves to treat the metallic fuel cell component for acceptance of the additional coating.

110. The fuel cell of claim 105, wherein the coating comprising a silane is sandwiched between the metallic fuel cell component and the additional coating.

111. The fuel cell of claim 58, wherein the silane is of the formula:
(RO)ₘSiR′ₙR″ₒR′″ₚ
where m+n+o+p=4 and m=1, 2 or 3;
R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4;
R′=CH₃—; CH₃(CH₂)_{q}—, where q=1-18 and the alkyl structure can be linear or branched; or —CH₂CH₂CH₂—Z,
where Z=NH₂, CN, Cl, SH, H, 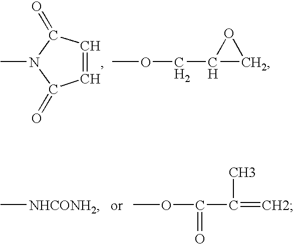
R″=R′ or R″.

112. The fuel cell of claim 58, wherein the silane is of the formula:
ClₘSiR′ₙR″ₒR′″ₚ
where m+n+o+p=4 and m=1, 2 or 3;
R′=CH₃—; CH₃(CH₂)_{q}—, where q=1-18 and the alkyl structure can be linear or branched; or —CH₂CH₂CH₂—Z,
where Z=NH₂, CN, Cl, SH, H, or 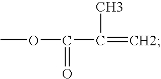
R″=H or R′
R′″=R″.

113. The fuel cell of claim 58, wherein the silane is of the formula:
(CH₃)₃Si—NH—Si(CH₃)₃.

114. The fuel cell of claim 58, wherein the silane is of the formula: 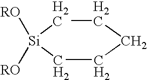
where R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4.

115. A fuel cell stack comprising a fuel cell comprising a metallic fuel cell component and a proton exchange membrane, wherein the metallic fuel cell component is at least partially coated with a coating comprising a silane.

116. The fuel cell stack of claim 115, wherein the coating is stable when in contact with or in close proximity to a proton exchange membrane and within anode and cathode environments of a fuel cell.

117. The fuel cell stack of claim 115, wherein the coating comprises a silane having the formula:
(RO)_{P}SiR′_{N}R″_{M}
where P+N+M=4 and P=2 or 3;
R=CH₃— or CH₃CH₂—
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1
R″=H

118. The fuel cell stack of claim 115, wherein the silane is selected from the group consisting of methyltrimethoxysilane, octadecyltrimethoxysilane, 3-aminopropyltriethoxysilane, N-(2-aminoethyl)-3-aminopropyltrimethoxysilane, and methyldimethoxysilane.

119. The fuel cell stack of claim 115, wherein the coating comprises a silane having the formula:
(RO)_{P}SiR′_{N}R″_{M}
where P+N+M=4 and P=1, 2 or 3;
R=CH₃(CH₂)ₙ—,
where n=0-18;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H

120. The fuel cell stack of claim 115, wherein the coating comprises a silane having the formula:
(RO)_{P}SiR′_{N}R″_{M}
where P+N+M=4 and P=1, 2 or 3;
R=CH3CO—, ethoxyethyl or ethoxybutyl;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1
R″=H

121. The fuel cell stack of claim 115, wherein the coating comprises a silane having the formula:
ClₓSiR_{y}
where y=1, 2 or 3 and x=4−y; and
R=CH₃—, CH₃CH₂—, H, or CH₃(CH₂)ₙ— where n=2-18.

122. The fuel cell stack of claim 115, wherein the coating comprises a silane having the formula:
(RO)_{P}SiR′_{N}R″_{M}
where P+N+M=4 and P=1, 2 or 3;
R=linear or branched alkyl groups of 1-19 carbons, cycloalkyl groups of 3-19 carbons, or alkyl aromatic groups;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H

123. The fuel cell stack of claim 115, wherein the coating comprises a silane containing at least one acylamino silane linkage and at least one alkene or arylene group.

124. The fuel cell stack of claim 123, wherein the silane is selected from the group consisting of gamma-ureidopropyltriethoxysilane, gamma-acetylaminopropyltriethoxysilane and delta-benzoylaminobutylmethyldiethoxysilane.

125. The fuel cell stack of claim 123, wherein the silane is a ureido silane.

126. The fuel cell stack of claim 125, wherein the silane is gamma-ureidopropyltriethoxysilane.

127. The fuel cell stack of claim 115, wherein the coating comprises a silane containing at least one cyano silane linkage and at least one alkene or arylene group.

128. The fuel cell stack of claim 127, wherein the silane is selected from the group consisting of cyanoeethyltrialkoxysilane, cyanopropytri-alkoxysilane, cyanoisobutyltrialoxysilane, 1-cyanobutyltrialkoxysilane, 1-cyanoisobutyltrialkoxysilane and cyanophenyltrialkoxysilane.

129. The fuel cell stack of claim 115, wherein the silane comprises a mercaptosilane.

130. The fuel cell stack of claim 129, wherein the mercaptosilane comprises a mercaptosilane of the formula:
(RO)_{c}SiR′_{d}R″ₑR′″_{f}
where c+d+e+f=4;
c=1, 2 or 3;
R=CH₃(CH₂)_{g}, where g=0-17 and R may be linear or branched; CH₃(CH₂)ₕ—O—CH₂(CH₂)ᵢ, where h=0-4 and i=1, 2 or 3;
R′=—CH₂CH₂CH₂SH
R″=R′, H, or CH₃(CH₂)_{g}, where g=0-17 and R may be linear or branched; and
R′″=R″.

131. The fuel cell stack of claim 129, wherein the mercaptosilane comprises a mercaptosilane of the formula:

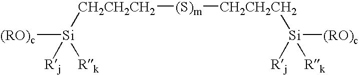

132. The fuel cell stack of claim 129, wherein the silane is selected from the group consisting of 3-glycidoxypropyltrimethoxysilane, 3-mercaptopropyltrimethoxysilane, 2-mercaptoethyltrimethoxysilane, 2-(3,4-epoxycyclohexyl)-ethyltrimethoxysilane, and partial hydrolyzates thereof.

133. The fuel cell stack of claim 115, wherein the silane comprises a tetrafunctional silane.

134. The fuel cell stack of claim 133, wherein the coating comprises between about 0.5% and about 20% by weight of the dried coating of tetrafunctional silane.

135. The fuel cell stack of claim 133, wherein the coating comprises between about 2% and about 5% by weight of the dried coating of tetrafunctional silane.

136. The fuel cell stack of claim 133, wherein the tetrafunctional silane comprises a tetraalkoxysilane.

137. The fuel cell stack of claim 133, wherein the tetrafunctional silane is selected from the group consisting of tetramethoxysilane, tetraethoxysilane and tetra-n-butoxysilane.

138. The fuel cell stack of claim 115, wherein the silane comprises a vinyl-polymerizable unsaturated hydrolizble silane.

139. The fuel cell stack of claim 138, wherein the vinyl-polymerizable unsaturated hydrolizble silane contains at least one silicon-bonded hydrolizable group.

140. The fuel cell stack of claim 139, wherein the silicon-bonded hydrolizable group is selected from the group consisting of alkoxy, halogen and aryloxy.

141. The fuel cell stack of claim 138, wherein the vinyl-polymerizable unsaturated hydrolizble silane contains at least one silicon-bonded vinyl-polymerizable unsaturated group.

142. The fuel cell stack of claim 141, wherein the vinyl-polymerizable unsaturated hydrolizble silane is selected from the group consisting of gamma-methacryloxypropyltrimethoxysilane, gamma-acryloxypropyltriethoxysilane, vinyltri(2-methoxyethoxy) silane, vinyltrimethoxysilane, vinyltriethoxysilane, vinyltrichlorosilane, vinyltriacetoxysilane, ethynytrimethoxysilane, ethynytriethoxysilane 2-propynyltrimethoxysilanesilane, 2-propynyltriethoxysilanesilane and 2-propynyltrichlorosilane.

143. The fuel cell stack of claim 115, wherein the silane comprises a vinyl-polymerizable unsaturated hydrolizble silane of the formula:
RₐSiX_{b}Y_{c}
wherein R is a monovalent hydrocarbon group;
X is a silicon-bonded hydrolyzable group;
Y is a silicon-bonded monovalent organic group containing at least one vinylpolymerizable unsaturated bond;
a is 0, 1 or 2;
b is 1, 2 or 3;
c is 1, 2 or 3;
and a+b+c=4.

144. The fuel cell stack of claim 143, wherein the monovalent hydrocarbon group is selected from the group consisting of methyl, ethyl, propyl, isopropyl, butyl, pentyl, isobutyl, isopentyl, octyl, decyl, cyclohexyl, cyclopentyl, benzyl, phenyl, phenylethyl and naphthyl and their isomers.

145. The fuel cell stack of claim 115, wherein the silane comprises a relatively low molecular weight vinyl-polymerizable unsaturated polysiloxane oligomer.

146. The fuel cell stack of claim 145, wherein the relatively low molecular weight vinyl-polymerizable unsaturated polysiloxane oligomer is of the formula:
R_{g}(R_{d}Y_{2-d}SiO)ₑ(R₂SiO)_{f}(SiR₃)_{g}
where R is a monovalent hydrocarbon group;
Y is a silicon-bonded monovalent organic group containing at least one vinylpolymerizable unsaturated bond;
d is 0 or 1;
e is 1, 2, 3 or 4;
f is 0, 1, 2 or 3;
g is 0 or 1;
e+f+g is equal to an integer of 1 to 5;
and d can be the same or different in each molecule.

147. The fuel cell stack of claim 145, wherein the relatively low molecular weight vinyl-polymerizable unsaturated polysiloxane oligomer is a cyclic trimer, a cyclic tetramer a linear dimer, a linear trimer, a linear tetramer or a linear pentamer.

148. The fuel cell stack of claim 115, wherein the silane is 2-(3,4-epoxycyclohexyl)-ethyltrimethoxysilane.

149. A fuel cell stack for low temperature fuel cells utilizing proton exchange membranes, wherein the plate is at least partially coated with a coating comprising a silazane.

150. The fuel cell stack of claim 149, wherein the silazane comprises polysilazane.

151. The fuel cell stack of claim 149, wherein the silazane comprises hexamethyldisilazane.

152. The fuel cell stack of claim 115, wherein the metallic fuel cell component is a bipolar separator plate.

153. The fuel cell stack of claim 152, wherein the bipolar separator plate comprises metal foil.

154. The fuel cell stack of claim 153, wherein the bipolar separator plate comprises stainless steel.

155. The fuel cell stack of claim 115, wherein the metallic fuel cell component is a current collector.

156. The fuel cell stack of claim 155, wherein the current collector comprises flat metallic wires.

157. The fuel cell stack of claim 156, wherein the current collector comprises stainless steel.

158. The fuel cell stack of claim 115, wherein the metallic fuel cell component is entirely coated with the coating.

159. The fuel cell stack of claim 115, wherein the metallic fuel cell component is partially coated with the coating.

160. The fuel cell stack of claim 115, wherein the metallic fuel cell component is coated only at areas that are in intimate contact with or close proximity to a proton exchange membrane when the metallic fuel cell component is incorporated into a fuel cell comprising the proton exchange membrane.

161. The fuel cell stack of claim 115, wherein the metallic fuel cell component is further coated with an additional coating.

162. The fuel cell stack of claim 161, wherein the additional coating comprises a polymer.

163. The fuel cell stack of claim 162, wherein the polymer is a conductive polymer.

164. The fuel cell stack of claim 162, wherein the polymer is a non-conductive polymer.

165. The fuel cell stack of claim 162, wherein the coating comprising a silane serves to adhere the additional coating to the metallic fuel cell component.

166. The fuel cell stack of claim 162, wherein the coating comprising a silane serves to treat the metallic fuel cell component for acceptance of the additional coating.

167. The fuel cell stack of claim 162, wherein the coating comprising a silane is sandwiched between the metallic fuel cell component and the additional coating.

168. The fuel cell stack of claim 115, wherein the silane is of the formula:
(RO)ₘSiR′ₙR″ₒR′″ₚ
where m+n+o+p=4 and m=1, 2 or 3;
R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4;
R′=CH₃—; CH₃(CH₂)_{q}—, where q=1-18 and the alkyl structure can be linear or branched; or —CH₂CH₂CH₂—Z,
where Z=NH₂, CN, Cl, SH, H, 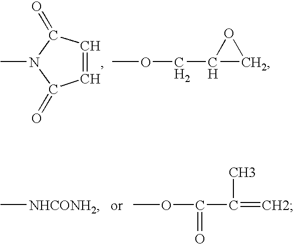
R″=R′ or R″; and
R′″=R″.

169. The fuel cell stack of claim 115, wherein the silane is of the formula:
ClₘSiR′ₙR″ₒR′″ₚ
where m+n+o+p=4 and m=1, 2 or 3;
R′=CH₃—; CH₃(CH₂)_{q}—, where q=1-18 and the alkyl structure can be linear or branched; or —CH₂CH₂CH₂—Z,
where Z NH₂, CN, Cl, SH, H, or 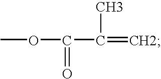
R″=H or R′
R′″=R″.

170. The fuel cell stack of claim 115, wherein the silane is of the formula:
(CH₃)₃Si—NH—Si(CH₃)₃.

171. The fuel cell stack of claim 115, wherein the silane is of the formula: 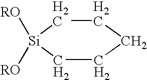
where R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4.

172. A method of protecting a metallic fuel cell component from corrosion comprising at least partially coating a metallic fuel cell component with a coating comprising a silane.

173. The method of claim 172, wherein the coating is stable when in contact with or in close proximity to a proton exchange membrane and within anode and cathode environments of a fuel cell.

174. The method of claim 172, wherein the coating comprises a silane having the formula:
(RO)_{P}SiR′_{N}R″_{M}
where P+N+M=4 and P=2 or 3;
R=CH₃— or CH₃CH₂—
R′=CH₃—, CH₃(CH₂)₁₇—, H₂N(CH₂)₃—, or H₂N(CH₂)₂[NH(CH₂)₂]_{Q}HN(CH₂)₃—, where Q=1 or 1
R″=H

175. The method of claim 172, wherein the silane is selected from the group consisting of methyltrimethoxysilane, octadecyltrimethoxysilane, 3-aminopropyltriethoxysilane, N-(2-aminoethyl)-3-aminopropyltrimethoxysilane, and methyldimethoxysilane.

176. The method of claim 172, wherein the coating comprises a silane having the formula:
(RO)_{P}SiR′_{N}R″_{M}
where P+N+M=4 and P=1, 2 or 3;
R=CH₃(CH₂)ₙ—,
where n=0-18;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H

177. The method of claim 172, wherein the coating comprises a silane having the formula:
(RO)_{P}SiR′_{N}R″_{M}
where P+N+M=4 and P=1, 2 or 3;
R=CH3CO—, ethoxyethyl or ethoxybutyl;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1
R″=H

178. The method of claim 172, wherein the coating comprises a silane having the formula:
ClₓSiR_{y}
where y=1, 2 or 3 and x=4−y; and
R=CH₃—, CH₃CH₂—, H, or CH₃(CH₂)ₙ— where n=2-18.

179. The method of claim 172, wherein the coating comprises a silane having the formula:
(RO)_{P}SiR′_{N}R″_{M}
where P+N+M=4 and P=1, 2 or 3;
R=linear or branched alkyl groups of 1-19 carbons, cycloalkyl groups of 3-19 carbons, or alkyl aromatic groups;
R′=CH₃—, CH₃(CH₂)₁₇—, H₂N(CH₂)₃—, or H₂N(CH₂)₂[NH(CH₂)₂]_{Q}HN(CH₂)₃—, where Q=0 or 1; and
R″=H

180. The method of claim 172, wherein the coating comprises a silane containing at least one acylamino silane linkage and at least one alkene or arylene group.

181. The method of claim 180, wherein the silane is selected from the group consisting of gamma-ureidopropyltriethoxysilane, gamma-acetylaminopropyltriethoxysilane and delta-benzoylaminobutylmethyldiethoxysilane.

182. The method of claim 180, wherein the silane is a ureido silane.

183. The method of claim 172, wherein the silane is gamma-ureidopropyltriethoxysilane.

184. The method of claim 172, wherein the coating comprises a silane containing at least one cyano silane linkage and at least one alkene or arylene group.

185. The method of claim 184, wherein the silane is selected from the group consisting of cyanoeethyltrialkoxysilane, cyanopropytri-alkoxysilane, cyanoisobutyltrialoxysilane, 1-cyanobutyltrialkoxysilane, 1-cyanoisobutyltrialkoxysilane and cyanophenyltrialkoxysilane.

186. The method of claim 172, wherein the silane comprises a mercaptosilane.

187. The method of claim 186, wherein the mercaptosilane comprises a mercaptosilane of the formula:
(RO)_{c}SiR′_{d}R″ₑR′″_{f}
where c+d+e+f=4;
c=1, 2 or 3;
R=CH₃(CH₂)_{g}, where g=0-17 and R may be linear or branched; CH₃(CH₂)ₕ—O—CH₂(CH₂)ᵢ, where h=0-4 and i=1, 2 or 3;
R′=—CH₂CH₂CH₂SH
R″=R′, H, or CH₃(CH₂)_{g}, where g=0-17 and R may be linear or branched; and
R′″=R″.

188. The method of claim 186, wherein the mercaptosilane comprises a mercaptosilane of the formula:

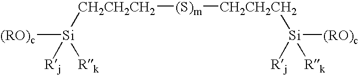

189. The method of claim 186, wherein the silane is selected from the group consisting of 3-glycidoxypropyltrimethoxysilane, 3-mercaptopropyltrimethoxysilane, 2-mercaptoethyltrimethoxysilane, 2-(3,4-epoxycyclohexyl)-ethyltrimethoxysilane, and partial hydrolyzates thereof.

190. The method of claim 172, wherein the silane comprises a tetrafunctional silane.

191. The method of claim 190, wherein the coating comprises between about 0.5% and about 20% by weight of the dried coating of tetrafunctional silane.

192. The method of claim 190, wherein the coating comprises between about 2% and about 5% by weight of the dried coating of tetrafunctional silane.

193. The method of claim 190, wherein the tetrafunctional silane comprises a tetraalkoxysilane.

194. The method of claim 190, wherein the tetrafunctional silane is selected from the group consisting of tetramethoxysilane, tetraethoxysilane and tetra-n-butoxysilane.

195. The method of claim 172, wherein the silane comprises a vinyl-polymerizable unsaturated hydrolizble silane.

196. The method of claim 195, wherein the vinyl-polymerizable unsaturated hydrolizble silane contains at least one silicon-bonded hydrolizable group.

197. The method of claim 196, wherein the silicon-bonded hydrolizable group is selected from the group consisting of alkoxy, halogen and aryloxy.

198. The method of claim 195, wherein the vinyl-polymerizable unsaturated hydrolizble silane contains at least one silicon-bonded vinyl-polymerizable unsaturated group.

199. The method of claim 198, wherein the vinyl-polymerizable unsaturated hydrolizble silane is selected from the group consisting of gamma-methacryloxypropyltrimethoxysilane, gamma-acryloxypropyltriethoxysilane, vinyltri(2-methoxyethoxy) silane, vinyltrimethoxysilane, vinyltriethoxysilane, vinyltrichlorosilane, vinyltriacetoxysilane, ethynytrimethoxysilane, ethynytriethoxysilane 2-propynyltrimethoxysilanesilane, 2-propynyltriethoxysilanesilane and 2-propynyltrichlorosilane.

200. The method of claim 172, wherein the silane comprises a vinyl-polymerizable unsaturated hydrolizble silane of the formula:
RₐSiX_{b}Y_{c}
wherein R is a monovalent hydrocarbon group;
X is a silicon-bonded hydrolyzable group;
Y is a silicon-bonded monovalent organic group containing at least one vinylpolymerizable unsaturated bond;
a is 0, 1 or 2;
b is 1, 2 or 3;
c is 1, 2 or 3;
and a+b+c=4.

201. The method of claim 200, wherein the monovalent hydrocarbon group is selected from the group consisting of methyl, ethyl, propyl, isopropyl, butyl, pentyl, isobutyl, isopentyl, octyl, decyl, cyclohexyl, cyclopentyl, benzyl, phenyl, phenylethyl and naphthyl and their isomers.

202. The method of claim 172, wherein the silane comprises a relatively low molecular weight vinyl-polymerizable unsaturated polysiloxane oligomer.

203. The method of claim 202, wherein the relatively low molecular weight vinyl-polymerizable unsaturated polysiloxane oligomer is of the formula:
R_{g}(R_{d}Y_{2-d}SiO)ₑ(R₂SiO)_{f}(SiR₃)_{g}
where R is a monovalent hydrocarbon group;
Y is a silicon-bonded monovalent organic group containing at least one vinylpolymerizable unsaturated bond;
d is 0 or 1;
e is 1, 2, 3 or 4;
f is 0, 1, 2 or 3;
g is 0 or 1;
e+f+g is equal to an integer of 1 to 5;
and d can be the same or different in each molecule.

204. The method of claim 202, wherein the relatively low molecular weight vinyl-polymerizable unsaturated polysiloxane oligomer is a cyclic trimer, a cyclic tetramer a linear dimer, a linear trimer, a linear tetramer or a linear pentamer.

205. The method of claim 172, wherein the silane is 2-(3,4-epoxycyclohexyl)-ethyltrimethoxysilane.

206. A method for low temperature fuel cells utilizing proton exchange membranes, wherein the plate is at least partially coated with a coating comprising a silazane.

207. The method of claim 206, wherein the silazane comprises polysilazane.

208. The method of claim 206, wherein the silazane comprises hexamethyldisilazane.

209. The method of claim 172, wherein the metallic fuel cell component is a bipolar separator plate.

210. The method of claim 209, wherein the bipolar separator plate comprises metal foil.

211. The method of claim 210, wherein the bipolar separator plate comprises stainless steel.

212. The method of claim 172, wherein the metallic fuel cell component is a current collector.

213. The method of claim 212, wherein the current collector comprises flat metallic wires.

214. The method of claim 213, wherein the current collector comprises stainless steel.

215. The method of claim 172, wherein the metallic fuel cell component is entirely coated with the coating.

216. The method of claim 172, wherein the metallic fuel cell component is partially coated with the coating.

217. The method of claim 172, wherein the metallic fuel cell component is coated only at areas that are in intimate contact with or close proximity to a proton exchange membrane when the metallic fuel cell component is incorporated into a fuel cell comprising the proton exchange membrane.

218. The method of claim 172, wherein the metallic fuel cell component is further coated with an additional coating.

219. The method of claim 218, wherein the additional coating comprises a polymer.

220. The method of claim 219, wherein the polymer is a conductive polymer.

221. The method of claim 219, wherein the polymer is a non-conductive polymer.

222. The method of claim 219, wherein the coating comprising a silane serves to adhere the additional coating to the metallic fuel cell component.

223. The method of claim 219, wherein the coating comprising a silane serves to treat the metallic fuel cell component for acceptance of the additional coating.

224. The method of claim 219, wherein the coating comprising a silane is sandwiched between the metallic fuel cell component and the additional coating.

225. The method of claim 172, wherein the silane is of the formula:
(RO)ₘSiR′ₙR″ₒR′″ₚ
where m+n+o+p=4 and m=1, 2 or 3;
R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4;
R′=CH₃—; CH₃(CH₂)_{q}—, where q=1-18 and the alkyl structure can be linear or branched; or —CH₂CH₂CH₂—Z,
where Z=NH₂, CN, Cl, SH, H, 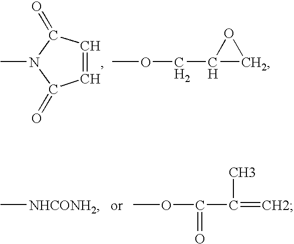
R″=R′ or R″; and
R′″=R″.

226. The method of claim 172, wherein the silane is of the formula:
ClₘSiR′ₙR″ₒR′″ₚ
where m+n+o+p=4 and m=1, 2 or 3;
R′=CH₃—; CH₃(CH₂)_{q}—, where q=1-18 and the alkyl structure can be linear or branched; or —CH₂CH₂CH₂—Z,
where Z=NH₂, CN, Cl, SH, H, or 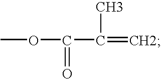
R″=H or R′
R′″=R″.

227. The method of claim 172, wherein the silane is of the formula:
(CH₃)₃Si—NH—Si(CH₃)₃.

228. The method of claim 172, wherein the silane is of the formula: 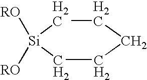
where R=CH₃—; CH₃(CH₂)_{q}—, where q=1-18 and the alkyl structure can be linear or branched; CH₃CO—; or CH₃(CH₂)ᵣ—O—CH₂CH₂—, where r=0, 1, or 4.

229. The method of claim 172, further comprising treating surface(s) of the fuel cell bipolar separator plate with sulfuric acid, rinsing with water, and rinsing with water vapor.

230. The method of claim 172, further comprising treating the fuel cell bipolar separator plate surface(s) with treating solvent.

231. The method of claim 230, wherein the treating solvent is anhydrous.

232. The method of claim 230, wherein the treating solvent is water soluble.

233. The method of claim 230, wherein the treating solvent is chosen from the group consisting of xylene and isopropanol.

234. The method of claim 172, further comprising immersing the plate in a silane coating liquid comprising silane, dilute acid, and demineralized, deionized water.

235. The method of claim 234, wherein the silane coating liquid further comprises silane coating liquid solvent.

236. The method of claim 235, wherein the silane coating liquid solvent is selected from the group consisting of isopropanol, xylene, and toluene.

237. The method of claim 234, wherein the dilute acid comprises dilute acetic acid.
